(19) United States
(12) Patent Application Publication
(10) Pub. No.: US 2026/0087692 A1
(43) Pub. Date: Mar. 26, 2026

(54) GRAPHICS PROCESSING

(71) Applicant: Arm Limited, Cambridge (GB)

(72) Inventors: Frank Klaeboe Langtind, Melhus (NO); Andreas Danner Nilsen, Trondheim (NO)

(73) Assignee: Arm Limited, Cambridge (GB)

(21) Appl. No.: 18/897,828

(22) Filed: Sep. 26, 2024

(51) Int. Cl. G06T 11/20

(52) U.S. Cl. CPC G06T 11/20

(57) ABSTRACT

A graphics processing system includes a graphics processor that executes a tile-based graphics processing pipeline. The graphics processing pipeline comprises a sequence of one or more geometry processing stages to perform geometry processing, a binning stage that generates data structures for identifying geometry to be processed for respective rendering tiles of a render output being generated, and a rendering stage for rendering tiles of a render output being generated. Some of the geometry processing of the graphics processing pipeline being executed can be deferred until the rendering stage. It is determined whether previously deferred geometry processing for a render output should no longer be deferred until the rendering stage, and, if so, an indication that previously deferred geometry processing should no longer be deferred until the rendering stage is provided to the graphics processor. The graphics processor then performs previously deferred geometry processing in response to the indication.

### BACKGROUND

The technology described herein relates to graphics processing, and in particular to tile-based graphics processing.

Graphics processing is normally carried out by first splitting a scene (e.g. a 3D model) to be rendered (e.g. for display) into a number of similar basic components or “primitives”, which primitives are then subjected to the desired graphics processing operations. The graphics primitives are usually in the form of simple polygons such as triangles, quadrilaterals, points, lines or groups thereof.

Each primitive is usually defined by and represented as a set of vertices (e.g. three vertices in the case of a triangular primitive). The vertices that are to be used for the primitives will have respective sets of vertex data defining the vertices, e.g. the relevant attributes for each of the vertices. These attributes will typically include position data and other, non-position data, e.g. defining colour, light, normal, texture coordinates, etc., for the vertex in question.

In tile-based graphics processing, the two-dimensional graphics processing output, such as an output frame to be displayed, is generated (rendered) as a plurality of smaller area regions, usually referred to as “tiles”. The output is typically divided (by area) into regularly-sized and shaped rendering tiles (they are usually e.g. squares or rectangles). The tiles are each rendered separately (e.g. one after another). The rendered tiles are then combined to provide the complete output (e.g. frame for display).

When performing tile-based graphics processing, there will normally be some initial geometry processing, such as vertex processing (vertex shading) of attributes for vertices to be used for primitives for the output being generated, to generate geometry (and other) data required for rendering the graphics processing output.

The geometry processing will then be followed by a tiling/binning process that generates appropriate data structures for determining which geometry (e.g. primitives) needs to be processed for respective rendering tiles of the output being generated.

(In tile-based graphics processing, it is usually desirable to be able to (try to) identify the geometry (e.g. primitives) that needs to be processed for a given rendering tile (so as to avoid unnecessarily processing geometry that does not actually apply to a rendering tile). To facilitate this, in tile-based graphics processing, there is usually a tiling/binning process that is performed that generates appropriate data structures, such as lists of primitives that apply to a tile or tiles, for use to then identify geometry that needs to be processed for a respective rendering tile.)

Once the binning/tiling process has generated the necessary data structures for identifying geometry to be processed for respective tiles of the output, the geometry can then be, and will be, subjected to appropriate rendering/fragment processing. This may comprise, for example, rasterising primitives to be processed to fragments, fragment shading of the fragments, and/or performing ray tracing operations. This operation is performed on a tile-by-tile basis, using the data structures generated by the tiling/binning process to identify the geometry (e.g. primitives) that need to be processed for a respective rendering tile.

The rendered tiles may then be combined appropriately to provide the overall output (e.g. frame for display).

The Applicants believe that there remains scope for improvements to the operation of tile-based graphics processors and tile-based graphics processing.

### BRIEF DESCRIPTION OF THE DRAWINGS

Embodiments of the technology described herein will now be described by way of example only and with reference to the accompanying drawings, in which:

FIG. 1 shows an exemplary data processing system in which the technology described herein may be implemented;

FIG. 2 shows an exemplary graphics processing pipeline;

FIG. 3 shows schematically a graphics processor that may be operated in accordance with the technology described herein;

FIG. 4 shows the geometry processing pipeline of the graphics processor of FIG. 3 in more detail;

FIG. 5 shows a distributed binning core of the graphics processor of FIG. 3 in more detail;

FIG. 6 is a flowchart showing the operation of a distributed binning core of the graphics processor;

FIG. 7 shows an exemplary binning data structure;

FIG. 8 shows a deferred shading control unit;

FIGS. 9 and 10 are flowcharts showing the operation of the deferred shading control unit;

FIGS. 11, 12, 13 and 14 show the use of memory heaps;

FIG. 15 shows the layout of a geometry buffer;

FIGS. 16 and 17 show exemplary binning data structures;

FIG. 18 shows the operation of the driver for the graphics processor in an embodiment;

FIGS. 19 and 21 are flow charts showing the operation of the graphics processor in an embodiment; and

FIG. 20 shows a deferred shader stage unit in an embodiment.

Like reference numerals are used for like features in the Figures, where appropriate.

### DETAILED DESCRIPTION

A first embodiment of the technology described herein comprises a method of operating a graphics processing system, the graphics processing system including a graphics processor that executes a tile-based graphics processing pipeline to generate an output, the graphics processing pipeline being executed comprising:
a sequence of one or more geometry processing stages to perform geometry processing;
a binning stage that generates data structures for identifying geometry to be processed for respective rendering tiles of a render output being generated; and
a rendering stage for rendering tiles of a render output being generated;
wherein some of the geometry processing of the sequence of one or more geometry processing stages of the graphics processing pipeline being executed can be deferred until the rendering stage for geometry being processed;
the method comprising:
determining that previously deferred geometry processing for a render output should no longer be deferred until the rendering stage;
in response to determining that previously deferred geometry processing for a render output should no longer be deferred until the rendering stage, providing an indication that previously deferred geometry processing should no longer be deferred until the rendering stage to the graphics processor; and
the graphics processor, in response to the indication, performing previously deferred geometry processing.

A second embodiment of the technology described herein comprises a graphics processing system, the graphics processing system comprising:
a graphics processor comprising processing circuits configured to execute a tile-based graphics processing pipeline to generate an output, the graphics processing pipeline comprising:
a sequence of one or more geometry processing stages to perform geometry processing;
a binning stage that generates data structures for identifying geometry to be processed for respective rendering tiles of a render output being generated; and
a rendering stage for rendering tiles of a render output being generated;
wherein some of the geometry processing of the sequence of one or more geometry processing stages of a graphics processing pipeline being executed can be deferred until the rendering stage for geometry being processed;
the graphics processing system further comprising:
a processing circuit configured to:
   determine whether previously deferred geometry processing for a render output should no longer be deferred until the rendering stage; and
   when it is determined that previously deferred geometry processing for a render output should no longer be deferred until the rendering stage, provide an indication that previously deferred geometry processing should no longer be deferred until the rendering stage;
the graphics processor further configured to:
in response to an indication that previously deferred geometry processing should no longer be deferred until the rendering stage, perform previously deferred geometry processing.

A third embodiment of the technology described herein comprises a graphics processor, the graphics processor comprising:
processing circuits configured to execute a tile-based graphics processing pipeline to generate an output, the graphics processing pipeline comprising:
a sequence of one or more geometry processing stages to perform geometry processing;
a binning stage that generates data structures for identifying geometry to be processed for respective rendering tiles of a render output being generated; and
a rendering stage for rendering tiles of a render output being generated;
wherein some of the geometry processing of the sequence of one or more geometry processing stages of a graphics processing pipeline being executed can be deferred until the rendering stage for geometry being processed;
the graphics processor further configured to:
in response to an indication that previously deferred geometry processing should no longer be deferred until the rendering stage, perform previously deferred geometry processing.

The technology described herein relates to tile-based graphics processing.

In the technology described herein geometry processing for geometry being processed can be deferred until the rendering stage.

The Applicants have recognised in this regard that, as will be discussed further below, not all of the geometry processing for geometry to be processed for a render output needs to be performed in advance of and for the binning/tiling stage in a tile-based graphics processing pipeline, but rather some of that processing can, where appropriate, be deferred until the rendering/fragment processing stage of the graphics processing pipeline (and, e.g., and in an embodiment, until it has been determined that the geometry in question actually applies to a rendering tile).

By deferring geometry processing to the rendering stage, the need to store the result of that processing from the geometry processing stage until it is required by the rendering stage is avoided.

Furthermore, at least some of the geometry processing that is performed in a deferred manner (at the rendering stage) can be, and is in an embodiment, omitted from the initial geometry processing operation (prior to the binning stage). This will then allow the amount of geometry processing that is initially performed to be reduced. Furthermore, that geometry processing for geometry that is in fact not required for any rendering tiles can be omitted completed.

The Applicants have further recognised that while for the above reasons it may generally be desirable to try to defer geometry processing to the rendering stage in a tile-based graphics processing pipeline, there can be circumstances where it is undesirable or inappropriate to defer geometry processing in this manner. This may in particular be, and is in an embodiment, the case where it is necessary to process the geometry in a defined order (for example in draw call order).

The Applicants have recognised in this regard that allowing geometry processing to be deferred to the rendering stage could lead to the geometry for a given render output (for example) being processed in a different order to the initially defined order for the geometry. Thus in the case where it is desired or required to retain a defined processing order for the geometry, the Applicants have recognised that deferring geometry processing should (normally) not be done.

The need to maintain and ensure a desired processing order for geometry for a render output can arise for any suitable and desired reason. For example, this may in particular be the case where the geometry processing has a “side effect”, that means that the geometry should be processed in a particular order. (A side effect is when the processing (e.g. shader) modifies a shared resource, such as shared memory, such that the output from processing (shaders) using (reading) the shared resource depends on execution order.)

The Applicants have further recognised in this regard that there can be dependencies between respective render outputs (e.g. draw calls) being generated, such that, for example, the respective render outputs need to complete their, e.g. geometry processing, in a particular order. This may, for example, be the case where an earlier render output (e.g. draw call) being processed is to read from a (memory) buffer that will then be written to by a later render output (draw call). In this case, it may be desirable to ensure that the earlier render output has completed all of its reads from the (memory) buffer before the later render output writes to the (memory) buffer.

The Applicants have further recognised that if there is such a dependency between different render outputs, and it is determined that geometry processing should not be deferred for the later render output (such that all of its geometry processing will be performed as part of the geometry processing stage prior to the binning stage), then equally any geometry processing that has been deferred for an earlier render output (for which there is a conflicting dependency with the later render output) should (in an embodiment) then be performed, prior to the geometry processing for the later render output being performed, so as to avoid the dependency conflict.

The technology described herein addresses this by determining whether previously deferred geometry processing for a render output should no longer be deferred until the rendering stage, and when it is determined that previously deferred geometry processing for a render output should no longer be deferred until the rendering stage, providing an indication that has the effect of causing previously deferred geometry processing (e.g. and in an embodiment for a previous render output) to be performed prior to the rendering stage (and, as will be discussed further below, in an embodiment immediately in response to the indication).

As will be discussed further below, the effect of this then is that when deferring geometry processing to the rendering stage in a tile-based graphics processing pipeline, any later potentially conflicting dependencies between render outputs having, e.g., “side effects” such that geometry processing should not be deferred, can be effectively and efficiently handled in hardware with relatively little cost and without, for example, the need to perform rendering for only some but not all of the geometry for a render output, and/or without requiring such situations to be handled in software (which can lead to a lot of complexity and overhead).

The technology described herein can and does accordingly provide an improved mechanism and operation for handling, inter alia, geometry processing that includes side effects in arrangements where geometry processing can be deferred until the rendering stage in a tile-based graphics processing pipeline.

The geometry processing that is and can be performed in the technology described herein can comprise any suitable and desired sequence of one or more geometry processing stages that may be performed as part of a graphics processing pipeline.

In an embodiment, the geometry processing comprises one or more of, and in an embodiment plural of, the following geometry processing stages: a position shader (position shading); a vertex shader (vertex shading); a tessellation control shader (tessellation control shading); a task shader (task shading); a tessellation shader (tessellation shading); a mesh shader (mesh shading); a tessellation evaluation shader (tessellation evaluation shading); a geometry shader (geometry shading); and a transform feedback shader (transform feedback shading). The geometry processing may comprise one or more of these shader stages, as desired.

The sequence of one or more geometry processing stages is in an embodiment implemented and executed as a geometry processing pipeline, comprising the sequence of one or more geometry processing stages in question.

The geometry processing may, in effect, operate on, and process, individual geometry elements, such as, and in an embodiment, (individual) primitives (and in one embodiment, that is the case). In this case geometry processing may be, and is in an embodiment, deferred for respective individual geometry elements (e.g. primitives), e.g. on a primitive-by-primitive basis.

In an embodiment the geometry processing, in effect, operates on, and processes, respective groups of geometry elements (such as, and in an embodiment, respective groups of primitives). In this case geometry processing may be, and is in an embodiment, deferred for respective groups of geometry elements (e.g. primitives), e.g. on a group of primitives-by-group of primitives basis.

In an embodiment the geometry processing generates (and processes) respective (geometry) packets that each store data for geometry to be processed (for the render output in question). In this case geometry processing may be, and is in an embodiment, deferred for respective individual (geometry) packets, e.g. on a (geometry) packet-by-(geometry) packet basis.

In an embodiment a (and each) (geometry) packet that the geometry processing generates stores data for a set of one or more primitives (and in an embodiment for a set of plural primitives) to be processed (for the render output in question).

Each (geometry) packet may store any suitable and desired data for the geometry (e.g. set of one or more primitives) that it relates to. For example, a (geometry) packet may, and in an embodiment does, store appropriate attributes, such as positions and varyings, for a set of (in an embodiment plural) vertices for the geometry (e.g. set of primitives) that the packet relates to, for example, and in an embodiment, together with a set of identifiers (indices) for the vertices that can be used to determine how the vertices are used for the geometry (e.g. primitives) that the packet relates to. A packet may also store attributes and identifiers for the geometry, e.g. primitives, itself, if desired, and/or other, e.g., state, information relating to the geometry that the packet relates to.

Other arrangements would, of course, be possible.

The initial (geometry) packets that are generated by the geometry processing may be created in any suitable and desired manner. For example geometry and/or work items (e.g. vertices) relating to that geometry may be progressively added to a packet, e.g. until a condition for finishing the packet (and, if necessary, starting a new packet), such as a maximum amount of geometry and/or work items for the packet being met, is reached.

In an embodiment, each respective geometry processing stage of the sequence of one or more geometry processing stages for the geometry processing (pipeline) that is being executed, generates a respective geometry packet(s), and provides that respective geometry packet as an input packet to a next geometry processing stage of the sequence (if any), with that next geometry processing stage of the sequence then processing the input packets that it receives to generate one or more output geometry packets, that are then provided as inputs to a next geometry processing stage of the sequence (if any), and so on.

Thus, in an embodiment, the first stage of the geometry processing, which in an embodiment comprises position shading or vertex shading (comprising both position shading and varying shading, for example), acts as an “input packetizer” that generates initial packets storing data for geometry to be processed. These initial geometry packets are then in an embodiment appropriately processed by (any) subsequent stages of the geometry processing to generate, for example, modified versions of the initial geometry packets and/or to generate additional geometry packets, as required. For example, a mesh shader may generate multiple packets from a single input (e.g. task shader) packet.

In the technology described herein geometry processing can be deferred until the rendering stage for geometry being processed. However, it can also be determined for a render output that no geometry processing for the render output should be deferred until the rendering stage.

Thus, in an embodiment, the possibility of deferring geometry processing can be selectively enabled, in an embodiment on a render output by render output (e.g. draw call) basis. Thus, for example, and in an embodiment, the possibility of deferring geometry processing is able to be set globally for a given render output (e.g. draw call), such that where deferred geometry processing is not enabled (is determined to not be performed) for a render output, all the geometry processing for the render output will be performed as part of the geometry processing prior to the binning stage. On the other hand, where deferred geometry processing is enabled for a render output, then it will be permitted for at least some of the geometry processing for the render output to be deferred to the rendering stage.

A render output in this regard (for which the possibility of deferring geometry processing can be enabled or disabled as a whole (globally)) can be any suitable and desired render output that the graphics processing being performed can be subdivided into (and that is identifiable (identified) as a distinct and separate (render) output of the overall graphics processing being performed). In an embodiment, the render output corresponds to a subset of the processing for producing an overall output, such an output frame (e.g. to be displayed). Thus the render output is in an embodiment one of a sequence of plural render outputs that together serve for generating an output frame or sequence of output frames.

In an embodiment, a (each) render output being considered in this regard comprises a (single) draw call, i.e. such that the deferring of geometry processing can be selectively disabled for draw calls (and a draw call) as a whole, i.e. on a draw call-by-draw call basis.

Where geometry processing is permitted to be deferred for a render output, geometry processing may be deferred for respective individual geometry elements, such as primitives, and on that individual geometry by geometry element basis (on a primitive by primitive basis) (and in one embodiment that is what is done), or the geometry processing may be deferred in respect of groups of plural geometry elements (e.g. groups of primitives) and deferred correspondingly on a geometry element group by geometry element group basis (and in another embodiment, that is what is done).

In an embodiment, the geometry processing is deferred for and in respect of, individual (respective) geometry packets (as discussed above), and so is performed on a geometry packet by geometry packet basis.

It would be possible simply to defer (some) geometry processing for all geometry (e.g. all primitives and/or all geometry packets) that are being processed for a render output (where enabled) (and in one embodiment that is what is done).

In an embodiment, geometry processing can be selectively deferred for (respective) geometry being processed (where enabled for a render output), for example, and in an embodiment, for respective primitives (on a primitive by primitive basis) and/or for respective geometry packets (on a geometry packet by geometry packet basis) (as appropriate).

Thus, in an embodiment, the method of the technology described herein comprises (and the graphics processor comprises a processing circuit or circuits configured to):
determining whether some geometry processing for geometry to be processed for a render output, and in an embodiment for a packet storing data for geometry to be processed for a render output, should be deferred until the rendering stage of (until after a binning stage of) the graphics processing pipeline being executed; and
when it is determined that some of the geometry processing should be deferred until the rendering stage of (until after the binning stage of) the graphics processing pipeline being executed, determining to defer some of the geometry processing until the rendering stage of (until after the binning stage of) the graphics processing pipeline being executed;
and
when it is determined that the geometry processing should not be deferred, performing all of the geometry processing for the geometry (packet) prior to the binning stage.

In these embodiments, the decision as to whether to defer geometry processing for geometry (e.g. a packet) can be based on any suitable and desired criteria.

For example, it could simply be based on how much geometry processing has already been deferred (e.g. how many previous packets have had geometry processing deferred), with there, for example, being a maximum amount of geometry (e.g. number of packets) for which the geometry processing is permitted to be deferred (e.g. for a given render output).

It could also or instead take account of and be based on whether the geometry processing that is (potentially) to be deferred will result in less (intermediate) data from that geometry processing needing to be stored until the rendering stage, as compared to the amount of (intermediate) data that would need to be stored until the rendering stage in the case that the geometry processing is deferred. For example, a mesh shader may generate plural output packets from a single input packet, and so it may be preferable to defer mesh shading where possible and appropriate, so as to reduce the amount of (intermediate) data that has to be stored.

Other arrangements and considerations would, of course, be possible.

The geometry processing that is (potentially) deferred to the rendering stage (from the geometry processing prior to the binning stage) may be any suitable and desired geometry processing (geometry processing stage) that is to be performed as part of the overall geometry processing sequence (pipeline) for the graphics processing pipeline being executed. In an embodiment, it comprises the last (final) geometry processing stage of the sequence of geometry processing stage(s) that are to be performed for the graphics processing pipeline being executed.

Thus in an embodiment, the geometry processing that is (potentially) deferred to the rendering stage comprises one or more, and in an embodiment the last one, of the geometry processing stages of the sequence of one or more geometry processing stages that are to be performed for the graphics processing pipeline being executed.

Thus, in the case where the sequence of one or more geometry processing stages for the graphics processing pipeline being executed comprises N geometry processing stages (where N is an integer greater than zero), the method of the technology described herein in an embodiment comprises (and the graphics processor is correspondingly in an embodiment configured to) determining whether to defer the Nth geometry processing stage until the rendering stage, and when it is determined to defer the Nth geometry processing stage until the rendering stage, performing N-1 of the geometry processing stages of the sequence of N geometry processing stages of the graphics processing pipeline being executed prior to the binning stage.

In an embodiment, the geometry processing that is (potentially) deferred to the rendering stage comprises one of: a vertex shader (vertex shading); a mesh shader (mesh shading); a tessellation evaluation shader (tessellation evaluation shading); a geometry shader (geometry shading); or a transform feedback shader (transform feedback shading).

At least in the case where geometry processing is (potentially) deferred on a primitive by primitive basis (for respective individual graphics primitives), the geometry processing that is (potentially) to the deferred rendering stage in an embodiment comprises a vertex shader (vertex shading), and, in an embodiment (at least) vertex varying shading.

The geometry processing that is (potentially) deferred from the initial geometry processing could comprise only some but not all of the relevant geometry processing (stage), but in an embodiment, all of the relevant processing for the geometry processing (stage) in question is deferred to the rendering stage.

Correspondingly, in an embodiment, at least some of the geometry processing that is determined to be deferred to the rendering stage is not performed (is other than performed) as part of the geometry processing prior to the binning stage (is omitted from the geometry processing for the geometry prior to the binning stage).

Thus, in the case where it is determined to defer some of the geometry processing until after the binning stage, then in an embodiment at least some of the geometry processing that is being deferred is not performed (is omitted) prior to the binning stage.

It would be possible in this regard for only some but not all of the relevant (deferred) geometry processing for the geometry processing (stage) to be omitted (not performed) prior to the binning stage, but in an embodiment none of the geometry processing that will be deferred to the rendering stage is performed as part of the geometry processing prior to the binning stage (all of the geometry processing for the geometry processing (stage) in question is deferred to the rendering stage).

When geometry processing for geometry (e.g. a primitive or geometry packet) is deferred, an indication is in an embodiment provided and, e.g., and in an embodiment, associated with the geometry, so it can be determined that the geometry has had (some of) its geometry processing deferred (so that such “deferred” geometry can then be identified at the rendering stage). This can be indicated in any suitable and desired way, but is in an embodiment done by associating some form of indicator that can be used to indicate that geometry processing has been deferred with the geometry in question.

Thus, in the case where the geometry processing produces geometry packets and geometry processing can be (potentially) deferred for geometry packets, in an embodiment when geometry processing for a packet is deferred, the packet is indicated as having had (some of) its geometry processing deferred (so that such a “deferred” packet can then be identified at the rendering stage). This indication can take any suitable and desired form, but is in an embodiment in the form of an indicator that can be used to indicate that geometry processing for the packet has been deferred (and so needs to be performed, where appropriate, at the rendering stage).

In an embodiment, the “deferred” indication is associated with (and stored with) the geometry, e.g. packet, in its entry or entries in the appropriate binning data structure or structures that the binning stage generates. Thus, for example, and in an embodiment, where the binning stage generates (hierarchies of) bounding boxes, for a, e.g. packet, for which geometry processing has been deferred, the binning data structure will store a bounding box for the, e.g. packet, and an indicator (e.g. flag) indicating that geometry processing for the, e.g. packet, has been deferred.

In the case where geometry processing for geometry, e.g. a packet, is deferred, then in an embodiment, any information and data necessary for the later performance of the geometry processing (for performing the deferred geometry processing (stage)) is stored appropriately, so as to allow the deferred geometry processing to be performed later, at the rendering stage.

This data can be any suitable and desired data that will be needed for performing the geometry processing at the rendering stage.

It may for example, and in an embodiment does, comprise any data, such as state data, that is required for performing the geometry processing in question.

Any state (e.g. shader configuration) information that is needed for performing the later geometry processing is in an embodiment stored in the binning data structures that are generated by the binning stage, for example, and in an embodiment, in association with appropriate entries for the, e.g. packet in question, in those binning data structures.

In the case of a geometry packet, in an embodiment any input packet or packets required for performing the deferred geometry processing for the packet are stored for later use.

The input packets for the geometry processing that is deferred are in an embodiment stored appropriately in memory so that they can be retrieved when the geometry processing is performed at the rendering stage. In an embodiment, the storing of input packets in this manner and for this purpose is tracked, so that duplicated storing of input packets can (try to) be avoided.

The determination of whether to defer geometry processing for geometry, e.g. a packet being processed by the geometry processing pipeline (when enabled for a render output), may be performed by any suitable and desired element and component of the graphics processor and of the graphics processing pipeline that is being executed.

This decision and determination could be made by the appropriate geometry processing pipeline stage, e.g. before the last geometry processing stage in the geometry processing pipeline being executed is started.

In an embodiment, the binning stage of the graphics processing pipeline determines whether or not to defer geometry shading for geometry, e.g. a packet. In an embodiment this decision is performed by the binning stage before the binning stage includes the geometry, e.g. packet, in (processes the geometry, e.g. packet, in respect of) the binning data structures that the binning stage generates.

Thus, in an embodiment, when the last stage of the geometry processing pipeline being executed is reached (and before that geometry processing stage is performed), that is signalled to the binning stage, for the binning stage to then determine whether that final geometry processing stage should be deferred or not.

(The final stage of a geometry processing pipeline that is being executed is in an embodiment indicated as such, such that reaching that final stage for geometry, e.g. a packet, can be identified and correspondingly signalled to the binning stage for this determination to take place.)

When it is determined that the geometry processing for geometry, e.g. a packet, should not be deferred, then the binning stage is in an embodiment operable to, and operates to, trigger the performance of the final geometry processing stage at that point. In this case therefore the geometry, e.g. packet, will be subjected to the final geometry processing stage, and then that “completely” processed geometry, e.g. geometry packet, will be, and is in an embodiment, returned to the binning stage for the binning stage to process that geometry, e.g. packet, accordingly.

On the other hand, when the binning stage determines that the final geometry processing stage should be deferred for geometry, e.g. a packet, then the binning stage in an embodiment does not trigger (other than triggers) the performance of the final geometry processing stage at that point, and instead, in an embodiment, then processes the geometry, e.g. packet, in its current form (i.e. as it is prior to the geometry processing that is to be deferred), to include the geometry, e.g. packet in a binning data structure or structures accordingly.

In this case therefore a geometry packet (for example) that will be subjected to the binning process will be a packet for which the geometry processing has not been completed. This being the case, the binning stage in an embodiment processes that “incompletely geometry processed” packet so as to be able to include the packet in a binning data structure or structures accordingly, but does not perform any further processing for the packet that it would normally perform when processing a “completely geometry processed” packet.

Thus, in embodiments at least, the binning stage will receive from the geometry processing either a “completely” geometry processed packet for processing, or a packet for which the geometry processing has not been completed (for example, and in an embodiment, a packet for which all but the final geometry processing stage has been completed).

The binning stage should, and in an embodiment does, process the geometry, e.g. packets, it receives for processing (whether “completely” geometry processed or not) to generate one or more data structures that can be used to determine whether (the respective) geometry, e.g. packets, should be processed for respective rendering tiles. Thus, the binning stage in an embodiment generates one or more data structures that can be used to determine whether geometry to be processed, e.g., and in an embodiment, packets storing data for geometry to be processed, should be processed for a rendering tile.

The “binning” data structures that are generated by the binning stage for this purpose can take any suitable and desired form. For example, they could comprise lists of geometry (e.g. primitives or geometry packets) to be processed for respective rendering tiles or sets of plural rendering tiles (which geometry, e.g. packet, “tile” lists can then be used to determine which geometry, e.g. primitives or packets, apply to a given tile).

In an embodiment, the (binning) data structures that can be used to determine whether geometry to be processed should be processed for a rendering tile comprise, in an embodiment hierarchies of, bounding boxes that can be used for that purpose.

Thus, in the case where the geometry processing generates and processes geometry packets storing data for a set of one or more primitives to be processed, in an embodiment, the (binning) data structures that can be used to determine whether packets storing data for a set of one or more primitives to be processed should be processed for a rendering tile comprise, in an embodiment hierarchies of, bounding boxes that can be used for that purpose. In an embodiment this comprises both bounding boxes for respective individual packets, together with bounding boxes for respective groups of plural packets (and, if desired, for respective groups of groups of plural packets, and so on, if desired).

In this case to determine geometry, e.g. packets, that should be processed for a rendering tile, the rendering tile can be, and will be, and in an embodiment is, compared against the respective bounding boxes to identify the geometry, e.g. those packets, that apply to the tile.

The binning stage can generate the data structures to be used to determine which geometry, e.g. packets, should be processed for a rendering tile in any suitable and desired manner. In an embodiment it uses an appropriate bounding box for geometry, e.g. a packet, for this purpose.

For example, in the case where the binning stage prepares lists of primitives or packets to be processed for tiles, a bounding box for a primitive or packet can be compared to the tiles' positions to identify which tile(s) the primitive or packet applies to.

In the case where the binning data structure(s) comprises bounding boxes for geometry, e.g. packets, the bounding box for geometry, e.g. a packet, can be included in those data structures appropriately.

The bounding box for geometry, e.g. a packet, for this purpose, can be determined in any suitable and desired manner.

For example, in the case where geometry processing for geometry, e.g. a packet, is not deferred (such that the geometry processing for the geometry, e.g. packet, will be completed prior to the binning stage), the binning stage in an embodiment derives a bounding box for the “completed” geometry, e.g. packet, to then use for processing the geometry, e.g. packet, for, and including the geometry, e.g. packet, in, the binning data structure or structures that the binning stage is generating.

In the case where the necessary information for determining a bounding box for the geometry, e.g. packet, in its “current” form is available from the geometry processing that has been performed, then that information from the geometry processing that has been performed can be, and is in an embodiment, used to determine a bounding box for the geometry, e.g. packet, in question.

Thus, in the case where a (the final) geometry processing stage is to be deferred for a packet, but the necessary information for determining a bounding box for the packet in its “current” form is available from the geometry processing that has been performed, then that information from the geometry processing that has been performed again can be, and is in an embodiment, used to determine a bounding box for the packet in question.

Alternatively, any necessary geometry processing, such as position/vertex shading, that is required to provide appropriately processed (transformed) vertex positions for vertices for primitives in the packet to allow a bounding box for the packet to be determined could be performed (and in one embodiment, that is the case). Thus, in this case, when the (final) stage of geometry processing is to be deferred for a packet, in an embodiment some geometry processing, such as position shading of vertices for primitives of the packet, is still performed, to allow a bounding box for the packet to be determined (but the complete geometry processing for the final stage of the geometry processing that is to be deferred will not be performed).

In an embodiment, the bounding box for a (deferred) packet is determined without (with other than) needing to perform (and performing) any position shading for vertices for primitives in the packet (where that information is not already available from the geometry processing that has been performed).

In one such embodiment, the bounding box is derived using information, e.g., and in an embodiment, from the application for which the graphics processing is being performed (application supplied information), for example, and in an embodiment, that defines a bounding volume for the packet and a way to transform the bounding volume to derive a bounding box for the packet. In this case therefore, there will be appropriate (meta) data associated with the packet, in an embodiment provided by the application, e.g. that defines a bounding volume for the packet and the way to transform the bounding volume to determine a bounding box for the packet. The binning stage will then use this information to determine a bounding box for the packet in question.

In an embodiment, the binning stage can also or instead, in an embodiment also, determine the bounding box for a packet from information that has been generated by a geometry processing stage or stage that has already been executed for the packet (and that precedes the geometry processing stage that is being deferred). This information can comprise any suitable and desired information that can allow a bounding box for a packet to be determined.

For example, in the case of a tessellation shader, the tessellation output may consist of barycentric coordinates (which will be expanded to vertices and primitives in a tessellation evaluation shader). In this case, the tessellation shader may be configured to provide the bounding volume in barycentric coordinates, with the tessellation evaluation shader being configured to transform those coordinates into screen space bounding box coordinates (which will then provide a bounding box for the packet in question).

Other arrangements would, of course, be possible.

In the case where geometry processing for a packet is not deferred, then in an embodiment the binning stage operates to process the (finished) (geometry) packet output by the (complete) geometry processing, to generate a processed (primitive) packet therefrom (which is then the packet that is included in the appropriate data structure that can be used to determine whether packets should be processed for a rendering tile (and that is then processed by the rendering stage)).

The processing that the binning stage performs on a geometry packet in this regard can comprise any suitable and desired processing, but in an embodiment comprises at least performing appropriate culling operations for the primitives in the geometry packet, e.g., and in an embodiment to, (try to) cull primitives based on the view frustum and/or the facing direction of the primitives.

The processing in an embodiment also comprises determining bounding boxes for the individual primitives in the (primitive) packet, and using those individual primitive bounding boxes to derive a bounding box for the (processed) primitive packet that the binning stage is generating, and to generate one or more binning data structures that can be used to determine whether the primitives should be processed for a rendering tile.

With regard to the latter processing, this may comprise generating appropriate lists of primitives to be processed for a rendering tile or sets of plural rendering tiles based on the primitive bounding boxes, and/or including the primitive bounding boxes in the bounding box based binning data structures that the binning stage generates, as appropriate.

(Thus the packets storing data for geometry (e.g. for sets of primitives) that the binning stage generates binning data structures for (and including) may be (geometry) packets containing data for geometry to be processed generated by (some but not all of) the complete geometry processing pipeline, and/or there may be (primitive) packets that have been generated from “completely processed” geometry packets generated by the (complete) geometry processing pipeline by the binning stage.)

Correspondingly, in the case where geometry processing can be and is deferred for respective individual primitives (on a primitive by primitive basis), then in the case where geometry processing for a primitive is not deferred, in an embodiment the binning stage operates to perform any desired further processing on the (finished) primitive following the (complete) geometry processing, such as, and in an embodiment, at least performing appropriate culling operations for the primitive, e.g., and in an embodiment, to (try to) cull the primitive based on the view frustum and/or the facing direction of the primitive.

The processing in an embodiment also comprises determining a bounding box for the primitive (if not already available/provided), and using that bounding box when generating a binning data structure or structures that can be used to determine whether the primitive should be processed for a rendering tile (for example to determine whether to include the primitive in list(s) of primitives to be processed for rendering tiles).

After the binning stage has generated the necessary data structure or structures to be used to determine whether geometry to be processed, e.g. packets storing data for geometry to be processed, should be processed for a rendering tile for a render output (e.g. draw call) being processed, then the rendering (rendering stage) for the output in question can be performed.

The rendering will be performed on a tile by tile basis (as the graphics processor is executing a tile based graphics processing pipeline), and so accordingly, the rendering stage will, and in an embodiment does, use the binning data structures generated by the binning stage to identify geometry, e.g. packets, to be processed for respective rendering tiles. Thus, for a (and each) rendering tile to be processed for generating the rendering output, the binning data structure(s) generated by the binning stage will be, and are in an embodiment, used to identify geometry, e.g. packets storing data for geometry, to be processed for the rendering tile in question.

This can be done in any suitable and desired manner, and should, and in an embodiment does, depend upon the nature of the binning data structures that the binning stage has generated. For example, where the binning stage generates lists of primitives and/or packets to be processed for respective rendering tiles or sets of rendering tiles, those lists can be used to identify the primitives and/or packets to be processed for a rendering tile. Where the binning stage generates (hierarchies of) bounding boxes, e.g. for packets, a rendering tile may be compared to the bounding boxes to determine the, e.g. packets, that need to be processed for the rendering tile.

(Correspondingly, the rendering stage in an embodiment should, and in an embodiment does, comprise an initial process of using the binning data structure(s) generated by the binning stage to identify geometry, e.g. packets, to be processed for rendering tiles (which may comprise identifying geometry, e.g. packets, to be processed for regions of the render output, as will be discussed further below).

Correspondingly, references herein to deferring geometry processing to the rendering stage refer to an intention to defer that geometry processing until after a binning data structure or structures has been used to identify geometry, e.g. packets, to be processed for rendering tiles (render output regions) (and deferring that geometry processing until after a binning data structure or structures has been used to identify geometry, e.g. packets, to be processed for rendering tiles (render output regions), unless triggered and performed earlier by the operation in the manner of the technology described herein (or otherwise)). Similarly, the further geometry processing that is performed for geometry, e.g. a packet, that has been determined as needing to be processed further for a rendering tile is correspondingly performed after (at least an initial) binning stage/process.)

When it is determined that geometry, e.g. a packet, should be processed further for a rendering tile, then in the case where geometry processing for the geometry, e.g. packet, in question has been deferred, any deferred geometry processing for the geometry, e.g. packet, should be, and is in an embodiment, performed, before performing any further processing in relation to the geometry, e.g. packet, for the rendering tile.

Thus, in an embodiment, when it is determined that geometry, e.g. a packet storing data for geometry, to be processed needs to be processed further for a rendering tile, it is then determined whether further (deferred) geometry processing needs to be performed for the geometry, e.g. packet, and when it is determined that further geometry processing needs to be performed for the geometry, e.g. packet, the further (deferred) geometry processing for the geometry, e.g. packet, is performed.

Thus, in an embodiment, the method of the technology described herein comprises (and the graphics processor comprises a processing circuit or circuits configured to):
for geometry, e.g. a packet storing data for geometry to be processed, that has been determined as needing to be processed further for a rendering tile:
determining whether further (deferred) geometry processing needs to be performed for the geometry, e.g. packet; and
when it is determined that further (deferred) geometry processing needs to be performed for the geometry, e.g. packet:
performing (the) further geometry processing for the geometry, e.g. packet.

Correspondingly, in an embodiment, the graphics processor comprises a processing circuit or circuits configured to:
determine, for geometry, e.g. a packet storing data for geometry to be processed, that has been determined as needing to be processed further for a rendering tile, whether further (deferred) geometry processing needs to be performed for the geometry, e.g. packet; and
when it is determined that further (deferred) geometry processing needs to be performed for the geometry, e.g. packet:
cause a processing circuit configured to trigger the performing of further geometry processing for geometry, e.g. a packet storing data for geometry to be processed, after it has been determined that the geometry, e.g. packet, needs to be processed further for a rendering tile to trigger the performing of further geometry processing for the geometry, e.g. packet (but when it is determined that further geometry processing does not need to be performed for the geometry, e.g. packet, not cause the processing circuit configured to trigger the performing of further geometry processing for geometry, e.g. a packet storing data for geometry to be processed, after it has been determined that the geometry, e.g. packet, needs to be processed further for a rendering tile to trigger the performing of further geometry processing for the geometry, e.g. packet).

It can be, and is in an embodiment, determined whether further geometry processing needs to be performed for geometry, e.g. a packet, by identifying that there is a “deferred geometry processing” indicator that associated with the geometry, e.g. a packet (as discussed above), e.g. stored for and with the geometry, e.g. packet, in the binning data structure(s), to thereby determine that geometry processing has been deferred for the geometry, e.g. packet.

When it is determined that geometry processing for geometry, e.g. a packet, has been deferred, then the geometry processing that was deferred for the geometry, e.g. packet, will be performed at the rendering stage. The geometry processing that is performed at this stage should, and in an embodiment does, comprise (all of) the geometry processing that was deferred from the initial geometry processing (prior to the binning stage). Thus it may, and in an embodiment does, comprise performing the final geometry processing stage of the geometry processing pipeline being executed for the geometry, e.g. packet, in question.

The deferred geometry processing that is performed at the rendering stage should, and in an embodiment does, use any input data, e.g. input packet or packets, and state (e.g. shader configuration) information, that was stored for the geometry, e.g. packet, for the deferred geometry processing being performed (as discussed above), so as to allow the deferred geometry processing to be performed appropriately.

The performance of the deferred geometry processing at the rendering stage can be triggered and controlled in any suitable and desired manner, and may be performed by any suitable and desired element and component of the graphics processor and of the graphics processing pipeline that is being executed.

In an embodiment, the binning stage triggers and controls the performance of any deferred geometry processing for geometry at the rendering stage (and in an embodiment in a corresponding manner to controlling and triggering the performance or not of the geometry processing that is (or is not) deferred as part of the (initial) geometry processing, as discussed above).

Thus, in an embodiment, for geometry, e.g. a packet, for which it has been determined at the rendering stage that further (deferred) geometry processing needs to be performed, that is in an embodiment signalled to the binning stage, for the binning stage to then trigger the performance of the geometry processing that has been deferred for the geometry, e.g. packet, in question (and as appropriate).

Once the deferred geometry processing for, e.g. a packet, has been completed, such that the packet has at that point been “completely” geometry processed, then in an embodiment, the binning stage operates to process the (now finished) (geometry) packet from the (complete) geometry processing, to generate a processed (primitive) packet therefrom (as discussed above).

In an embodiment, as discussed above, the binning stage also determines at this stage bounding boxes for the individual primitives in the (primitive) packet, and updates the binning data structure or structures for the render output being generated accordingly (as discussed above, in the case where all of the geometry processing for a packet is performed prior to the binning stage).

The binning stage in an embodiment marks (sets) the geometry, e.g. packet, as not (as no longer) having any geometry processing “deferred” for it, e.g. in the updated binning structure(s), so that when the updated binning structure or structures are used, the geometry, e.g. packet, will be seen as being “complete”, and not needing further geometry processing to be performed for it (as that further geometry processing will now have been done). This will avoid, for example, further geometry processing for geometry, e.g. a packet, being performed multiple times at the rendering stage.

As will be appreciated from the above, when performing deferred geometry processing for geometry, e.g. a packet, at the rendering stage, the result of that processing (e.g. the processed (primitive) packet and any updated binning data structure(s)), will need to be stored for use when rendering the tile in question.

The geometry, e.g. packet, and other data that is generated at this point can be stored in any suitable and desired manner. In an embodiment, it is stored as and in a portion of memory that is intended to have a shorter lifetime than the (portion of) memory where completed geometry, e.g. primitive packets, and binning data structures that are generated by the binning stage prior to the rendering stage are stored.

The Applicants have recognised in this regard that while fully (geometry) processed primitive packets that are generated prior to and as part of the binning stage may need to be retained as (intermediate) data for, e.g., the entirety, of the time while a render output is being generated in its entirety, any fully processed (primitive) packets that are generated by performing deferred geometry shading at the rendering stage may only be required when rendering the particular tile or tiles in question that the packet has been determined as applying to.

In this case therefore, any later, fully geometry processed primitive packets may be able to be discarded once the rendering tile or tiles to which they apply have been rendered, such that those packets can be, and are in an embodiment, discarded once they have been used. (Whereas any fully processed primitive packets that are generated as part of the initial geometry processing pipeline and binning stage should be retained until the render output itself has been completed, as it may not be possible to determine when those packets will no longer be needed during the rendering process for the render output in question.)

It would be possible to identify geometry, e.g. packets, that need to be processed for a rendering tile and whether any of that geometry (those packets) have had any geometry processing deferred (and to then perform the deferred geometry processing) on a tile by tile basis (and in one embodiment that is what is done).

In an embodiment, the render output being generated is divided into a plurality of regions (by area), each region corresponding, for example, to a respective set of plural tiles, with the process then comprising (and the graphics processor being configured to) determining which geometry, e.g. packets, need to be processed when rendering a respective region, whether any of that geometry (those packets) require further (deferred) geometry processing to be performed, and then performing any required further (deferred) geometry processing (and further packet processing for packets), as required, and once any necessary deferred geometry processing (and packet processing) has been performed for geometry, e.g. packets, that apply to the region, then performing the rendering/fragment processing for the region.

In these arrangements, even when a region of the render output that is being considered is larger than an individual rendering tile, the region is in an embodiment still rendered as respective individual rendering tiles (on a rendering tile by rendering tile basis).

The rendering/fragment processing that is performed for a tile can be any suitable and desired rendering/fragment processing that may be performed by a graphics processor and a graphics processing pipeline. Thus this may comprise, for example, rasterising primitives to fragments and fragment shading the fragments, and/or performing ray tracing processes, etc.

When performing the rendering, the result of any further geometry processing that was triggered at the rendering stage should be, and is in an embodiment, used when processing geometry, e.g. a packet, for a rendering tile. This can comprise any suitable and desired processing and use of the results of the further geometry processing, as desired (and will, e.g., depend upon exactly what further geometry processing etc. has been performed for the geometry, e.g. packet, in question). For example, it may result in modified and/or additional packets to be processed for a tile.

In an embodiment, where the geometry comprises geometry packets, it comprises using the result of the further geometry processing when processing the packet for the rendering tile to determine which primitives that the packet relates to apply to the rendering tile. (As discussed above, in an embodiment the result of the further geometry processing is in an embodiment used to update the binning data structures for the render output to allow it to be determined whether primitives stored in a packet to be processed should be processed for a rendering tile.)

Other arrangements would, of course, be possible.

In an embodiment, and where the graphics processor has the processing resources (e.g. processing (shader) cores) to support such operation, once the rendering/fragment processing for a region of a render output (e.g. draw call) has been started, the corresponding processing of a next region to be processed for the render output in question, and in particular the determination of whether there is any geometry (e.g. are any packets) for which geometry processing has been deferred for the next region, and the triggering and the performance of that deferred geometry processing, is in an embodiment started and performed before the rendering/fragment processing has finished for the preceding region of the render output. In other words, in an embodiment, the determination of geometry, e.g. packets, to be processed for a region, and the triggering and performance of any deferred geometry processing for geometry, e.g. packets, for that region is in an embodiment started while rendering/fragment processing is being performed for a preceding region of the render output in question (or for a different render output). This can then facilitate more efficient processing of a given render output.

The above primarily describes the operation in the technology described herein where the possibility of deferring geometry processing for geometry for a render output until the rendering stage is enabled, and is, for example, and in an embodiment, decided on, e.g. a geometry packet-by-geometry packet basis.

As discussed above, in the technology described herein it can be determined that previously deferred geometry processing for a render output should no longer be deferred until the rendering stage.

This determination can be based on any suitable and desired condition(s) or criteria(s) that can be used to identify when previously deferred geometry processing for a render output should no longer be deferred until the rendering stage. Thus there will, for example, and in an embodiment, be a determination of whether a condition indicating that previously deferred geometry processing for a render output should no longer be deferred until the rendering stage has been met, and in response to determining that the condition has been met, an indication that previously deferred geometry processing should no longer be deferred until the rendering stage then being provided to the graphics processor.

The condition or conditions that determine that previously deferred geometry processing for a render output should no longer be deferred until the rendering stage can be any suitable and desired such condition(s). There could be a single condition that is considered for this regard, or there could be plural conditions that are considered. In an embodiment if any one condition is met, it is then determined that previously deferred geometry processing for a render output should no longer be deferred until the rendering stage.

Thus in an embodiment, there are plural conditions that determine that previously deferred geometry processing for a render output should no longer be deferred until the rendering stage that are considered, and if any one of those conditions is met, it is then determined that previously deferred geometry processing for a render output should no longer be deferred until the rendering stage.

In an embodiment, a or the condition is that geometry processing for a render output should not be deferred until the rendering stage (and, in an embodiment, that no geometry processing for geometry for a render output should be deferred until the rendering stage).

Thus in an embodiment, the method of the technology described herein comprises determining for a render output to be generated whether geometry processing for the render output should not be deferred until the rendering stage (whether no geometry processing for geometry for the render output should be deferred until the rendering stage) (and when it is determined for a render output to be generated that geometry processing for geometry for the render output should not be deferred until the rendering stage, providing an indication that previously deferred geometry processing should no longer be deferred until the rendering stage).

Correspondingly, a further embodiment of the technology described herein comprises a method of operating a graphics processing system, the graphics processing system including a graphics processor that executes a tile-based graphics processing pipeline to generate an output, the graphics processing pipeline being executed comprising:
a sequence of one or more geometry processing stages to perform geometry processing;
a binning stage that generates data structures for identifying geometry to be processed for respective rendering tiles of a render output being generated; and
a rendering stage for rendering tiles of a render output being generated;
wherein some of the geometry processing of the sequence of one or more geometry processing stages of the graphics processing pipeline being executed can be deferred until the rendering stage for geometry being processed;
the method comprising:
determining for a render output to be generated that no geometry processing for geometry for the render output should be deferred until the rendering stage;
in response to determining for a render output to be generated that no geometry processing for geometry for the render output should be deferred until the rendering stage, providing an indication that previously deferred geometry processing should no longer be deferred until the rendering stage to the graphics processor; and
the graphics processor, in response to the indication, performing previously deferred geometry processing.

Another embodiment of the technology described herein comprises a graphics processing system, the graphics processing system comprising:
a graphics processor comprising processing circuits configured to execute a tile-based graphics processing pipeline to generate an output, the graphics processing pipeline comprising:
a sequence of one or more geometry processing stages to perform geometry processing;
a binning stage that generates data structures for identifying geometry to be processed for respective rendering tiles of a render output being generated; and
a rendering stage for rendering tiles of a render output being generated;
wherein some of the geometry processing of the sequence of one or more geometry processing stages of a graphics processing pipeline being executed can be deferred until the rendering stage for geometry being processed;
the graphics processing system further comprising:
a processing circuit configured to:
   determine for a render output to be generated whether no geometry processing for geometry for the render output should be deferred until the rendering stage; and
   when it is determined for a render output to be generated that no geometry processing for geometry for the render output should be deferred until the rendering stage, provide an indication that previously deferred geometry processing should no longer be deferred until the rendering stage; the graphics processor further configured to:
in response to an indication that previously deferred geometry processing should no longer be deferred until the rendering stage, perform previously deferred geometry processing.

As discussed above, a render output in this regard (for which a determination that geometry processing for geometry for the render output should not be deferred until the rendering stage is considered and can be made) should be, and is in an embodiment, a “self-contained”, identifiable and separate render output of and for the (overall) graphics processing being performed. In an embodiment, a (and each) render output for which a determination as to whether geometry processing for geometry for the render output should not be deferred until the rendering stage is made (is performed) is a (respective) (single) draw call of and for the graphics processing being performed.

Thus, in an embodiment, the method of the technology described herein comprises determining for a draw call to be generated that (whether) geometry processing for geometry for the draw call should not be deferred until the rendering stage.

Correspondingly, the graphics processing system in an embodiment comprises a processing circuit configured to determine for a draw call to be generated whether geometry processing for geometry for the draw call should not be deferred until the rendering stage.

In an embodiment, it is determined for (and in an embodiment for plural, and in an embodiment for each) render output of a sequence of plural render outputs (e.g. draw calls) to be generated (e.g. for overall graphics processing that is being performed, e.g. to generate (a sequence of) one or more output frames, e.g. for display), whether geometry processing for geometry for the render output should not be deferred until the rendering stage.

It can be determined that geometry processing for geometry for a render output (e.g. draw call) should not be deferred until the rendering stage in any suitable and desired manner, and based on any suitable and desired condition(s) or criteria.

In an embodiment, this determination is based on whether it is necessary to ensure that geometry processing for the render output (draw call) in question should be (is required to be) performed in a particular order, for example, and in an embodiment, in the order that the geometry is (initially) defined for the render output. In an embodiment when it is determined that the geometry for a render output (e.g. draw call) should (must) be processed in a particular order, it is correspondingly determined that no geometry processing for geometry for the render output should be deferred until the rendering stage.

It can be determined that the geometry for render output should (must) be processed in a particular order in any suitable and desired manner.

In an embodiment, the determination that (of whether) no geometry processing for geometry for a render output (e.g. draw call) should be deferred until the rendering stage is based on whether the geometry processing for the render output has any side effects or not (e.g., and in an embodiment, modifies (e.g. writes to) a shared resource or not).

In an embodiment, when the geometry processing for geometry for a render output has a side effect or side effects, it is correspondingly determined that geometry processing for geometry for the render output should not be deferred until the rendering stage.

Thus, in an embodiment, it is determined that no geometry processing for geometry for a render output (e.g. draw call) should be deferred until the rendering stage when, and in response to, the geometry processing for geometry for the render output having a side effect(s).

Correspondingly, another embodiment of the technology described herein comprises a method of operating a graphics processing system, the graphics processing system including a graphics processor that executes a tile-based graphics processing pipeline to generate an output, the graphics processing pipeline being executed comprising:
a sequence of one or more geometry processing stages to perform geometry processing;
a binning stage that generates data structures for identifying geometry to be processed for respective rendering tiles of a render output being generated; and
a rendering stage for rendering tiles of a render output being generated;
wherein some of the geometry processing of the sequence of one or more geometry processing stages of the graphics processing pipeline being executed can be deferred until the rendering stage for geometry being processed;
the method comprising:
determining that a render output to be generated has a side effect;
in response to determining that a render output to be generated has a side effect, providing an indication that previously deferred geometry processing should no longer be deferred until the rendering stage to the graphics processor; and
the graphics processor, in response to the indication, performing previously deferred geometry processing.

Another embodiment of the technology described herein comprises a graphics processing system, the graphics processing system comprising:
a graphics processor comprising processing circuits configured to execute a tile-based graphics processing pipeline to generate an output, the graphics processing pipeline comprising:
a sequence of one or more geometry processing stages to perform geometry processing;
a binning stage that generates data structures for identifying geometry to be processed for respective rendering tiles of a render output being generated; and
a rendering stage for rendering tiles of a render output being generated;
wherein some of the geometry processing of the sequence of one or more geometry processing stages of a graphics processing pipeline being executed can be deferred until the rendering stage for geometry being processed;
the graphics processing system further comprising:
a processing circuit configured to:
   determine for a render output to be generated whether the render output has a side effect; and
   when it is determined for a render output to be generated that the render output has a side effect, provide an indication that previously deferred geometry processing should no longer be deferred until the rendering stage; the graphics processor further configured to:
in response to an indication that previously deferred geometry processing should no longer be deferred until the rendering stage, perform previously deferred geometry processing.

The fact that geometry for a render output needs to be processed in a particular order, and/or that the geometry processing for a render output has a side effect(s), can be identified and determined in any suitable and desired manner.

For example, and in an embodiment, this may be determined and identified from, and based on, desired geometry processing for the render output that is indicated by the application that requires (is requesting) the graphics processing in question, for example, and in an embodiment, based on the graphics API calls/commands indicated by (specified by) the application that the graphics processing is for (that is requesting the graphics processing).

For example, it may be able to be determined from the graphics processing that is to be performed, that the graphics processing for a render output includes a side effect, such that no geometry processing for a geometry for the render output should be deferred until the rendering stage, and/or that the geometry for a render output needs to be processed in a particular order.

A condition for determining that previously deferred geometry processing for a render output should no longer be deferred until the rendering stage may also or instead, and in an embodiment also, be a barrier (a barrier command) in the sequence of graphics processing to be performed, that indicates that processing before the barrier should be completed before processing after the barrier is performed.

For example, the sequence of graphics processing that is defined (by the application) may include a “barrier” (a “barrier” command) that indicates that processing (e.g., and in an embodiment, that all shaders) prior to the barrier should be completed before proceeding past the barrier. In this case, the presence of such a barrier can be taken to indicate, and is in an embodiment is taken to indicate, that any previously deferred geometry processing for a render output (prior to the barrier) should no longer be deferred until the rendering stage.

Thus, in an embodiment, it is determined that previously deferred geometry processing for a render output should no longer be deferred until the rendering stage based on, and in response to, there being a “barrier” in the sequence of processing for the graphics output to be generated (defined/provided by the application that is requesting the graphics processing), e.g. that indicates that processing (in an embodiment that all shaders) prior to the barrier should be completed before passing the barrier.

Correspondingly, another embodiment of the technology described herein comprises a method of operating a graphics processing system, the graphics processing system including a graphics processor that executes a tile-based graphics processing pipeline to generate an output, the graphics processing pipeline being executed comprising:
a sequence of one or more geometry processing stages to perform geometry processing;
a binning stage that generates data structures for identifying geometry to be processed for respective rendering tiles of a render output being generated; and
a rendering stage for rendering tiles of a render output being generated;
wherein some of the geometry processing of the sequence of one or more geometry processing stages of the graphics processing pipeline being executed can be deferred until the rendering stage for geometry being processed;
the method comprising:
determining that there is a barrier in a sequence of processing for a graphics output to be generated that indicates that processing prior to the barrier should be completed before passing the barrier;
in response to determining that there is a barrier in a sequence of processing for a graphics output to be generated that indicates that processing prior to the barrier should be completed before passing the barrier, providing an indication that previously deferred geometry processing should no longer be deferred until the rendering stage to the graphics processor; and
the graphics processor, in response to the indication, performing previously deferred geometry processing.

Another embodiment of the technology described herein comprises a graphics processing system, the graphics processing system comprising:
a graphics processor comprising processing circuits configured to execute a tile-based graphics processing pipeline to generate an output, the graphics processing pipeline comprising:
a sequence of one or more geometry processing stages to perform geometry processing;
a binning stage that generates data structures for identifying geometry to be processed for respective rendering tiles of a render output being generated; and
a rendering stage for rendering tiles of a render output being generated;
wherein some of the geometry processing of the sequence of one or more geometry processing stages of a graphics processing pipeline being executed can be deferred until the rendering stage for geometry being processed;
the graphics processing system further comprising:
a processing circuit configured to:
   determine whether there is a barrier in a sequence of processing for a graphics output to be generated that indicates that processing prior to the barrier should be completed before passing the barrier; and
   when it is determined that there is a barrier in a sequence of processing for a graphics output to be generated that indicates that processing prior to the barrier should be completed before passing the barrier, provide an indication that previously deferred geometry processing should no longer be deferred until the rendering stage;
the graphics processor further configured to:
in response to an indication that previously deferred geometry processing should no longer be deferred until the rendering stage, perform previously deferred geometry processing.

In the technology described herein, in response to it being determined that previously deferred geometry processing for a render output (e.g. draw call) should no longer be deferred until the rendering stage, an indication that previously deferred geometry processing should no longer be deferred until the rendering stage is provided.

The indication that is provided in this regard can be any suitable any desired indication that can indicate to and be recognised by the graphics processor as meaning that previously deferred geometry processing should no longer be deferred until the rendering stage.

In an embodiment, the indication is provided as part of (and in an embodiment in) the sequence of processing that is indicated to the graphics processor for causing the graphics processor to perform the desired graphics processing for the graphics processing that is to be performed.

For example, and in an embodiment, an application requiring graphics processing may provide an appropriate indication of the graphics processing that is required (e.g. as a sequence of API commands/calls), which requested graphics processing will then be, where appropriate, converted into an appropriate form, and provided as a sequence of graphics processing to be performed to the graphics processor, with the graphics processor then operating to perform the indicated sequence of graphics processing. In such an arrangement, the indication that previously deferred geometry processing should no longer be deferred until the rendering stage can be, and is in an embodiment, indicated within and as part of the sequence of graphics processing to be performed that is indicated to the graphics processor.

The sequence of graphics processing that the graphics processor is to perform can be indicated to the graphics processor in any suitable and desired manner. For example, it may comprise an appropriate sequence of commands (e.g. a command stream) to be executed by the graphics processor and/or a set of descriptors indicating a sequence of graphics processing to be performed by the graphics processor. In either case, the indication that previously deferred geometry processing should no longer be deferred until the rendering stage could be, and is in an embodiment, included appropriately in the sequence of commands/set of descriptors accordingly.

The indication can take any suitable and desired form (and this may depend, for example, whether it is included as a command in a sequence of commands or as part of a descriptor indicating graphics processing to be performed, for example).

In an embodiment, the indication is in the form of a “barrier” in the sequence of graphics processing (that is provided to the graphics processor), which barrier when encountered in the sequence of graphics processing has the effect of causing previously deferred geometry processing (that has yet to be performed) to now be performed.

Thus, in an embodiment, the indication comprises a barrier command in the sequence of geometry processing commands (the geometry processing command stream) that is provided to the graphics processor.

The indication (e.g. barrier) could simply indicate (and be taken to indicate) that any and all previously deferred (and still outstanding) geometry processing should no longer be deferred until the rendering stage (and in one embodiment, that is the case).

However, it would also be possible for the indication to provide an indication of and identify that particular, e.g., and in an embodiment, selected, previously deferred geometry processing should no longer be deferred until the rendering stage, but with other previously deferred geometry processing still being allowed to be deferred until the rendering stage, if desired. This would then allow a more finely grained control of the performing of previously deferred geometry processing, e.g. in the case where there may be a later conflicting dependency with a render output for which no geometry processing can be deferred until the rendering stage, so as to allow previously deferred geometry processing that can still be safely deferred until the rendering stage still to be so deferred, but triggering the performance of any previously deferred geometry processing that should no longer be deferred.

Thus, in an embodiment, the indication that previously deferred geometry processing should no longer be deferred until the rendering stage includes an indication of (indicates) particular previously deferred geometry processing that should no longer be deferred until the rendering stage, i.e. an indication of particular (which) previously deferred geometry processing the indication that previously deferred geometry processing should no longer be deferred until the rendering stage applies to.

Such an indication of particular geometry processing that should no longer be deferred until the rendering stage can take any suitable and desired form. For example, it may be in the form of an appropriate identifier that indicates the geometry processing that should no longer be deferred. For example, the indication may indicate the particular (geometry) shaders that now should all be completed even if they have previously been deferred.

In an embodiment, the indication can, and in an embodiment does, indicate (particular) geometry processing (e.g., and in an embodiment, the (geometry) shaders) that should not be done (that should be blocked/stalled) until the desired previously deferred geometry processing has been completed.

In an embodiment, the indication that is provided indicates which (geometry) shaders should no longer be deferred until the rendering stage, and which (geometry) shaders have to wait for that processing (e.g. the barrier) to be completed (met).

In the case where the indication is in the form of a “barrier” in the sequence of graphics processing, the barrier is in an embodiment included in the sequence of graphics processing (immediately) preceding the render output for which no geometry processing should be deferred, such that the presence of the barrier in the sequence of graphics processing will cause all (desired) previously deferred geometry processing (that is still outstanding) prior to the barrier to be performed, and no geometry processing to be deferred for the render output (immediately) following the barrier (with which the barrier is associated).

As discussed above, in practice the graphics processing that is being performed will comprise a sequence of (plural) render outputs (e.g. draw calls) to be generated. Accordingly, when it is determined that no geometry processing for geometry for a render output should be deferred until the rendering stage, the corresponding indication that previously deferred geometry processing should no longer be deferred until the rendering stage that is provided will, in effect, and is in an embodiment, an indication that geometry processing for a previous render output (i.e. that precedes the render output for which it has been determined that no geometry processing for geometry for the render output should be deferred until the rendering stage in the sequence of render outputs being generated) (and in an embodiment for plural and in an embodiment for all previous render outputs) should no longer be deferred until the rendering stage.

Thus, in an embodiment, the technology described herein comprises (and the graphics processing system is correspondingly configured to) when it is determined that previously deferred geometry processing for a render output should no longer be deferred until the rendering stage, providing an indication that (any) geometry processing from a (and in effect, and in an embodiment, all) previous (preceding) render output(s) that has been deferred to the rendering stage should no longer be deferred until the rendering stage.

The determination of whether geometry processing for a render output should no longer be deferred until the rendering stage (and, in an embodiment, the corresponding providing of an indication that previously deferred geometry processing should no longer be deferred until the rendering stage) can be performed and done by any suitable and desired element or component of the overall graphics processing system that the graphics processor is part of.

In an embodiment, particularly in the case where the determination is based on an indication of the geometry processing that is required, the determination (and in an embodiment the provision of the indication) is made by and done by a driver for the graphics processor (which driver, e.g., and in an embodiment, in an embodiment executes on another processor, such as a host processor, of the overall data processing system that the graphics processor is part of).

In such arrangements, the driver will, and in an embodiment does, receive appropriate indications of graphics processing to be performed, e.g., and in an embodiment, from an application that requires graphics processing, e.g., and in an embodiment, in the form of appropriate API commands/calls for required graphics processing. The driver will then prepare a corresponding sequence of graphics processing operations to be performed by the graphics processor to perform the desired graphics processing, and provide to the graphics processor an appropriate indication, e.g. sequence of commands (e.g. command stream) and/or set of descriptors, indicating the processing that is to be performed, with the graphics processor in response to those, e.g. commands/descriptors, then performing the desired graphics processing.

In the case of operation in the manner of the technology described herein, the driver for the graphics processor will, in an embodiment, identify from the sequence of graphics processing indicated by an application a condition indicating that previously deferred geometry processing for a render output that is being generated as part of the sequence of graphics processing should no longer be deferred until the rendering stage (e.g., and in an embodiment, as discussed above based on some form of side effect or “barrier” in the indicated sequence of graphics processing), and then, correspondingly, provide an appropriate indication that previously deferred geometry processing should no longer be deferred until the rendering stage in the sequence of graphics processing (e.g. the sequence of commands/set of descriptors) that it correspondingly provides to the graphics processor, for example, and in an embodiment, by including an appropriate and corresponding “barrier” in the sequence of graphics processing that is provided to the graphics processor for the graphics processor to cause the graphics processor to perform the desired graphics processing.

In the technology described herein, in response to an (the) indication that previously deferred geometry processing should no longer be deferred until the rendering stage, previously deferred geometry processing is performed (and the graphics processor is correspondingly configured to perform previously deferred geometry processing in response to an indication that previously deferred geometry processing should no longer be deferred until the rendering stage).

Thus, in an embodiment, in the case where the indication is included as part of the indicated sequence of processing to be performed by the graphics processor that is provided to the graphics processor (e.g. in the form of a barrier in that sequence of graphics processing), once and when the indication (e.g. barrier) in the sequence of graphics processing is reached by the graphics processor, previously deferred geometry processing will be performed.

The previously deferred geometry processing that is performed in this regard should be, and is in an embodiment, geometry processing that has previously been deferred until the rendering stage (and that has not yet been performed, e.g. because the render output that the geometry processing was deferred in respect of has not yet reached the rendering stage). (Any previously deferred geometry processing that has already reached the rendering stage will, as discussed above, correspondingly already have been triggered and/or be in progress as part of the rendering stage for the render output in question, and so the technology described herein is concerned with, and in particular with, the triggering and performing of deferred geometry processing that has yet to reach the rendering stage (that is “currently” deferred and that has not yet reached the rendering stage).)

As discussed above, the previously deferred geometry processing that is performed in response to the indication the previously deferred geometry processing should no longer be deferred until the rendering stage could, and in one embodiment does, comprise any and all “currently” deferred geometry processing, or there could be a more fine-grained check to identify particular geometry processing that should no longer be deferred, with other geometry processing still being allowed to be deferred (as discussed above). For example, it could be tracked in a more fine-grained manner what processing different render outputs (e.g. draw calls) and/or different (geometry) shaders are to perform, e.g. in terms of the buffers that they use, and that information used to determine whether and which geometry processing (if any) should no longer be deferred, if desired.

As discussed above, the graphics processing will typically be (and is in an embodiment) performed as the sequence of render outputs (e.g. and in an embodiment draw calls). Thus the previously deferred geometry processing that is performed in response to the indication that previously deferred geometry processing should no longer be deferred until the rendering stage should be, and is in an embodiment, geometry processing that has been deferred for a render output that preceded the render output for which it has been determined that no geometry processing for geometry for the render output should be deferred until the rendering stage in the sequence of render outputs that are being performed (and which has not yet reached the rendering stage).

Correspondingly, in the case where the indication that previously deferred geometry processing should no longer be deferred until the render stage is in the form of a barrier in the sequence of (geometry) processing that is to be performed, the previously deferred geometry processing that is performed in response to the indication (barrier) that previously deferred geometry processing should no longer be deferred until the rendering stage should be, and is in an embodiment, geometry processing that has been deferred for a render output that preceded the indication (barrier) in the sequence of geometry processing that is being performed (and which has not yet reached the rendering stage).

In one embodiment, any and all geometry processing that has been deferred is performed for any preceding render outputs that have not yet reached the rendering stage, or, as discussed above, selected geometry processing for such render outputs, and/or geometry processing for selected such render outputs, could be performed, depending, for example, on whether the indication that previously deferred geometry processing should no longer be deferred until the rendering stage identifies particular geometry processing that should no longer be deferred (or not).

The Applicants have recognised in this regard that when there is a sequence of render outputs (e.g. draw calls) being processed, with each render output undergoing geometry processing, followed by a binning stage, followed by a rendering stage, then in the case where there is an indication that previously deferred geometry processing should no longer be deferred until the rendering stage, there may be render outputs preceding that indication in the sequence that have already reached the rendering stage, there may be render outputs that are undergoing the binning stage but have not yet reached the rendering stage, and there may be render outputs that are still undergoing geometry processing.

In response to the indication indicating that previously deferred geometry processing should no longer be deferred until the rendering stage, any render outputs that have already reached the rendering stage can be processed by and through the rendering stage in the normal manner (since they will have any deferred geometry processing triggered for them as part of the rendering stage, as discussed above).

For any preceding render outputs that have completed their geometry processing (and, e.g., and in an embodiment, undergone the binning stage) but have not yet reached the rendering stage (are waiting to be rendered), then any deferred geometry processing for such render outputs should be, and is in an embodiment, triggered and performed (as appropriate) for those render outputs (before they reach the rendering stage).

For any preceding render outputs that are still undergoing geometry processing, then any geometry processing that has already been deferred for those render outputs should be, and is in an embodiment, triggered and performed, and any remaining geometry processing for the render output completed (with any (further) deferring of geometry processing for the render output in an embodiment being disabled (not performed) (i.e. such that any (remaining) geometry processing for the render output will be completed without any of the geometry processing being deferred until the rendering stage).

Thus, in an embodiment, the method of the technology described herein comprises, in response to the indication indicating that previously deferred geometry processing should no longer be deferred until the rendering stage:
for a (and in an embodiment for any) render output that has completed its geometry processing but has not yet reached the rendering stage (is waiting to be rendered), triggering and performing any deferred geometry processing for the render output that is still to be performed; and
for a (and in an embodiment for any) render output that is still undergoing geometry processing, completing all remaining geometry processing for the render output (in an embodiment without deferring any of the geometry processing until the rendering stage), and (in an embodiment thereafter) triggering and performing any geometry processing that has been deferred for the render output.

The graphics processor is correspondingly in an embodiment configured to perform these operations and to operate in this manner for respective render outputs (that are “in flight”) in response to an indication that previously deferred geometry processing should no longer be deferred until the rendering stage.

Thus, in an embodiment, the graphics processor is configured to (and includes a processing circuit or circuits configured to):
in response to an indication indicating that previously deferred geometry processing should no longer be deferred until the rendering stage:
for a (and in an embodiment for any) render output that has completed its geometry processing but has not yet reached the rendering stage (is waiting to be rendered), trigger and perform any deferred geometry processing for the render output that is still to be performed; and
for a (and in an embodiment for any) render output that is still undergoing geometry processing, triggering and performing any geometry processing that has already been deferred for the render output, and completing all remaining geometry processing for the render output without deferring any of the geometry processing until the rendering stage.

When performing previously deferred geometry processing in response to an indication that previously deferred geometry processing should no longer be deferred until the rendering stage, the previously deferred geometry processing that should now be performed can be identified (and the performance of that geometry processing triggered) in any suitable and desired manner.

In an embodiment, this is done in a corresponding manner to the way that deferred geometry processing is identified and triggered at the rendering stage, i.e. by identifying from the binning data structure or structures for the render output in question the geometry processing that has been deferred (e.g., and in an embodiment, geometry packets for which geometry processing has been deferred), and then correspondingly triggering that geometry processing, e.g., and in an embodiment, in the manner discussed above.

Correspondingly, any previously deferred geometry processing that is triggered in response to an indication that previously deferred geometry processing should no longer be deferred until the rendering stage can be and is in an embodiment performed in any suitable and desired manner, and an embodiment is (generally) performed in a corresponding (the same) manner to the way that deferred geometry processing is performed when triggered at the rendering stage (e.g., and in an embodiment, in the manner discussed above).

Correspondingly, in an embodiment, when any previously deferred geometry processing is performed, the corresponding binning data structures or structures processing and updating is also accordingly and correspondingly performed, e.g., and in an embodiment, in the manner discussed above, i.e. in the corresponding manner to what is done when deferred geometry processing is triggered and performed at the rendering stage.

It should be noted in this regard that in the operation of the technology described herein when triggering and performing previously deferred geometry processing in this manner, it should be, and is in an embodiment, only the (deferred) geometry processing that is performed, together with any appropriate binning processing and updating of the binning data structures, and that (in an embodiment) no rendering of the geometry should be or is performed (in response to an indication that previously deferred geometry processing should no longer be deferred), i.e. the previously deferred geometry processing is (in an embodiment) performed without triggering and performing any rendering of that geometry. (Rather, and in an embodiment, the geometry processing for a render output, including updating the binning data structures, is in an embodiment fully completed for the render outputs in question, but with those “completed” render outputs and binning data structures then simply being provided to the rendering stage for rendering in the normal manner (for the graphics processor and graphics processing pipeline in question).)

The Applicants have recognised that when triggering and performing deferred geometry processing for render outputs in the manner of the technology described herein, the requirement to store data for and/or generated by the performing of the deferred geometry processing could lead to an “out of memory” situation for the graphics processor. Should such an out of memory situation arise, then that can be handled in any suitable and desired manner, and is in an embodiment handled in the normal manner for out of memory situations for the graphics processor and graphics processing system in question (e.g. by stalling some or all of the processing until further memory is allocated/becomes available, for example, or in any other suitable and desired manner).

So far as a (the) render output that triggered the performing of previously deferred geometry processing, e.g., and in an embodiment for which it has been determined that no geometry processing for geometry for the render output should be deferred until the rendering stage and/or that follows a barrier in the sequence of processing, is concerned (e.g., and in an embodiment, that is associated with the indication that previously deferred geometry processing should no longer be deferred until the rendering stage, and/or immediately following a “barrier” to that effect in the sequence of processing provided to the graphics processor), that render output should and in an embodiment does undergo its geometry processing without any geometry processing being deferred until the rendering stage.

Thus, a (the) render output, e.g., for which it has been determined that no geometry processing should be deferred until the rendering stage, should and in an embodiment does undergo the complete geometry processing (for the geometry processing pipeline to be executed for that render output) prior to the binning stage. Thus in this case, all the processing stages of the geometry processing pipeline being executed will be performed for the geometry for the render output in question prior to the binning stage, and the binning stage will correspondingly be provided with “completely” geometry processed geometry (with “complete” geometry packets, for example) (which the binning stage will then process accordingly).

In an embodiment, the geometry processing for a (the) render output that is associated with the indication that previously deferred geometry processing should no longer be deferred until the rendering stage, and/or that (immediately) follows a “barrier” to that effect in the sequence of processing provided to the graphics processor (e.g. a render output for which it has been determined that no geometry processing should be deferred until the rendering stage) is not performed (and in an embodiment is not started) until all previously deferred geometry processing that is to be performed has been performed.

Thus, in an embodiment, the method of the technology described herein comprises (and the graphics processor/processing system is correspondingly configured to) not performing (other than performing) any geometry processing for a render output that is associated with an indication that previously deferred geometry processing should no longer be deferred until the rendering stage, and/or that (immediately) follows a “barrier” to that effect in the sequence of processing provided to the graphics processor (e.g. a render output for which it has been determined that no geometry processing should be deferred until the rendering stage) until after all the required previously deferred geometry processing has been performed (i.e. performing the desired previously deferred geometry processing and, thereafter, then starting the geometry processing for the render output that is associated with the indication that previously deferred geometry processing should no longer be deferred until the rendering stage, and/or that (immediately) follows a “barrier” to that effect in the sequence of processing provided to the graphics processor (e.g. a render output for which it has been determined that no geometry processing should be deferred until the rendering stage)).

This can be achieved in any suitable and desired manner. In an embodiment, this is achieved by stalling the geometry processing for the render output, e.g., for which it has been determined that no geometry processing should be deferred until the rendering stage, until the (desired) previously deferred geometry processing has been completed. In an embodiment, this is correspondingly done in response to the indication that previously deferred geometry processing should no longer be deferred until the rendering stage.

Thus, in an embodiment, the method of the technology described herein comprises (and the graphics processor is correspondingly configured to), in response to an indication that previously deferred geometry processing should no longer be deferred until the rendering stage (e.g. an appropriate “barrier” in the sequence of processing provided to the graphics processor), stalling the geometry processing (and not performing any geometry processing) for the render output that the indication is associated with (and in an embodiment the geometry processing for a (and any) render outputs that follow the indication (e.g. the barrier in the sequence of processing provided the graphics processor), performing previously deferred geometry processing (as discussed above, in an embodiment for one or more other, preceding render outputs), and when the previously deferred geometry processing has been performed, performing (starting) the geometry processing for the stalled render output(s) (e.g. that it has been determined that no geometry processing should be deferred until the rendering stage for) (releasing any stalled render outputs and performing geometry processing for the stalled render outputs).

Thus, in an embodiment, the method of the technology described herein comprises (and the graphics processor is correspondingly configured to), in response to a barrier indicating that previously deferred geometry processing should no longer be deferred until the rendering stage in the sequence of processing provided to the graphics processor, stalling the geometry processing (and not performing any geometry processing) for any render outputs that follow the barrier in the sequence of processing provided to the graphics processor, performing previously deferred geometry processing for one or more render outputs that preceded the barrier in the sequence of processing provided to the graphics processor, and when the previously deferred geometry processing has been performed, performing (starting) the geometry processing for the render output(s) that follows the barrier in the sequence of processing provided to the graphics processor.

In order to facilitate this operation, in an embodiment, it is appropriately signalled, e.g. and in an embodiment to an appropriate control/controller for the sequence of one or more geometry processing stages of the graphics processor, when (once) the (required) deferred geometry processing has been completed, so that the geometry processing for a (and any) stalled render output (e.g. and in an embodiment, for the render output for which it has been determined that no geometry processing should be deferred until the rendering stage) can be started (performed).

Thus, in an embodiment, the method of the technology described herein comprises (and the graphics processor is correspondingly configured to), when the previously deferred geometry processing has been performed (in response to an indication (e.g. a barrier) that previously deferred geometry processing should no longer be deferred until the rendering stage), signalling that the previously deferred geometry processing has been performed (has been completed), and in response to the signal starting and performing the geometry processing for the (stalled) render output, e.g. that it has been determined that no geometry processing should be deferred until the rendering stage for (starting the geometry processing for a (the) render output that follows the barrier indicating that previously deferred geometry processing should no longer be deferred until the rendering stage in the sequence of processing provided to the graphics processor).

The geometry processing for any render outputs that follow an indication (e.g. a barrier) that previously deferred geometry processing should no longer be deferred until the rendering stage can be handled and performed in any suitable and desired manner.

For example, it could be set that no geometry processing can be deferred until the rendering stage for one or more of the render outputs that follow the indication (e.g. barrier) the previously deferred geometry processing should no longer be deferred until the rendering stage. This is at least in an embodiment the case for the render output that triggered (that is associated with) the indication that previously deferred geometry processing should no longer be deferred until the rendering stage (e.g. the render output for which it was determined that no geometry processing for geometry for the render output should be deferred until the rendering stage).

In an embodiment, the deferring of geometry processing to the rendering stage is (again) permitted (enabled) for render outputs following an (the) indication that previously deferred geometry processing should no longer be deferred until the rendering stage. In an embodiment this is the case for all render outputs following the indication, e.g., and in an embodiment, save for the render output that triggered (that is associated with) the indication that previously deferred geometry processing should no longer be deferred until the rendering stage, unless (and until) a condition that means previously deferred geometry processing should no longer be deferred until the rendering stage is met (arises) again.

Thus in an embodiment, the method of the technology described herein comprises (and the graphics processor is correspondingly configured to) deferring (where possible) geometry processing for render outputs until a condition that means that previously deferred geometry processing should no longer be deferred arises, which will then trigger the stalling of later render outputs and the performing of any outstanding deferred geometry processing for preceding render outputs, and when that previously deferred geometry processing has been completed, continuing processing later render outputs in the normal manner, including (in an embodiment) again deferring geometry to the rendering stage (where possible) until a condition that indicates that that should not be done arises again.

Correspondingly, when generating a sequence of render outputs (e.g. draw calls), e.g. for an overall render output to be generated, there may be repeated sequences of allowing geometry processing to be deferred to the rendering stage for draw calls, followed by triggering performing previously deferred geometry processing, followed by again allowing geometry processing to be deferred to the rendering stage for draw calls, followed by triggering performing previously deferred geometry processing, and so on.

It will be appreciated from the above, that in general there will be a sequence of render outputs (e.g. draw calls) being generated, and it may be determined for a render output in the sequence that no geometry processing for geometry for the render output should be deferred until the rendering stage, with the operation of the technology described herein then being performed for any preceding render outputs in the sequence that are still “in flight”.

Any following render outputs, that are later in the sequence than the render output for which it has been determined that no geometry processing should be deferred until the rendering stage can then revert to being handled in the “normal manner”, i.e. with it being determined whether geometry processing for the render output can be deferred until the rendering stage or not, with the render output and other render outputs in the sequence then being handled and processed accordingly. Thus, and in particular, a determination that no geometry processing for geometry for a render output should be deferred until the rendering stage may and in an embodiment does affect the processing and handling of preceding render outputs to that render output, but in an embodiment does not affect or change the handling of any following render outputs.

The operation of the graphics processor in the manner of the technology described herein can be implemented and controlled in any suitable and desired manner, and by any suitable and desired element or component of the graphics processor.

In an embodiment, the graphics processor includes a controller (control circuit) associated with the geometry processing stages (the geometry processing pipeline) of the graphics processor (that the graphics processor executes), that is operable to and configured to stall a render output(s) (and in an embodiment any following render output(s)) from entering the sequence of geometry processing stages (the geometry processing pipeline) in response to an indication that previously deferred geometry processing should no longer be deferred until the rendering stage (e.g., and in an embodiment, a “barrier” (command) to that effect).

In an embodiment, the sequence of geometry processing stages (the geometry processing pipeline) also has a (different) controller (control circuit) at the end of the sequence of geometry processing stages (the geometry processing pipeline) that, when it sees the indication (e.g. the barrier), triggers the performing of previously deferred geometry processing (in an embodiment any outstanding previously deferred geometry processing).

In this arrangement, the indication (e.g. barrier) that previously deferred geometry processing should no longer be deferred until the rendering stage is in an embodiment, in effect, passed through the sequence of geometry processing stages (the geometry processing pipeline) (and the graphics processor is correspondingly configured for that to happen), so that when the indication (e.g. barrier) enters the sequence of geometry processing stages, a (and in an embodiment any) following render output is stalled before entering the sequence of geometry processing stages, with any render outputs that are currently undergoing the geometry processing and that precede the indication (e.g. barrier) then passing through the sequence of geometry processing stages (geometry processing pipeline) in the normal manner, “followed” by the indication (e.g. barrier), such that once the indication (e.g. barrier) reaches the end of the sequence of geometry processing stages (the geometry processing pipeline) it can be known that all render outputs preceding the indication (e.g. barrier) will have (completely) passed through the sequence of geometry processing stages (the geometry processing pipeline), with any deferred geometry processing then being triggered and performed.

Correspondingly, in this arrangement, when all the (desired) deferred geometry processing has been performed, that is then in an embodiment signalled (as discussed above) back to the control at the beginning of the sequence of geometry processing stages (the geometry processing pipeline), so that the stalled render output(s) can then be released and permitted to enter and undergo the sequence of geometry processing stages (the geometry processing pipeline).

Other arrangements would, of course, be possible.

The above describes the main elements and operation of the graphics processor and graphics processing pipeline that are relevant to operation in the manner of the technology described herein.

As will be appreciated by those skilled in the art, the graphics processor can otherwise include and execute, and in an embodiment does include and execute, any one or one or more, and in an embodiment all, of the processing stages and circuits that graphics processors and graphics processing pipelines may (normally) include.

In an embodiment, the graphics processor comprises, and/or is in communication with a memory system, one or more memories, and/or memory devices that store the data described herein, and/or that store software for performing the processes described herein. The graphics processor may also be in communication with a host microprocessor, and/or with a display for displaying images based on the output of the graphics processor.

The output to be generated may comprise any output that can and is to be generated by the graphics processor and processing pipeline. Thus it may comprise, for example, a tile to be generated in a tile based graphics processing system, and/or a frame of output fragment data. The technology described herein can be used for all forms of output that a graphics processor and processing pipeline may be used to generate, such as frames for display, render to texture outputs, etc., In an embodiment, the output is an output frame, and in an embodiment an image.

In an embodiment, the various functions of the technology described herein are carried out on a single graphics processing platform that generates and outputs the (rendered) data that is, e.g., written to a frame buffer for a display device.

The various functions of the technology described herein can be carried out in any desired and suitable manner. For example, unless otherwise indicated, the functions of the technology described herein can be implemented in hardware or software, as desired. Thus, for example, unless otherwise indicated, the various functional elements, stages, and “means” of the technology described herein may comprise a suitable processor or processors, controller or controllers, functional units, circuitry, circuits, processing logic, microprocessor arrangements, etc., that are configured to perform the various functions, etc., such as appropriately dedicated hardware elements (processing circuits/circuitry) and/or programmable hardware elements (processing circuits/circuitry) that can be programmed to operate in the desired manner.

It should also be noted here that, as will be appreciated by those skilled in the art, the various functions, etc., of the technology described herein may be duplicated and/or carried out in parallel on a given processor. Equally, the various processing stages may share processing circuitry/circuits, etc., if desired.

Furthermore, unless otherwise indicated, any one or more or all of the processing stages of the technology described herein may be embodied as processing stage circuits, e.g., in the form of one or more fixed-function units (hardware) (processing circuits), and/or in the form of programmable processing circuits that can be programmed to perform the desired operation. Equally, any one or more of the processing stages and processing stage circuitry of the technology described herein may be provided as a separate circuit element to any one or more of the other processing stages or processing stage circuits, and/or any one or more or all of the processing stages and processing stage circuits may be at least partially formed of shared processing circuits.

Subject to any hardware necessary to carry out the specific functions discussed above, the graphics processor can otherwise include any one or more or all of the usual functional units, etc., that graphics processors include.

It will also be appreciated by those skilled in the art that all of the described embodiments of the technology described herein can, and, in an embodiment, do, include, as appropriate, any one or more or all of the features described herein.

The methods in accordance with the technology described herein may be implemented at least partially using software e.g. computer programs. It will thus be seen that the technology described herein may provide computer software specifically adapted to carry out the methods herein described when installed on a data processor, a computer program element comprising computer software code portions for performing the methods herein described when the program element is run on a data processor, and a computer program comprising code adapted to perform all the steps of a method or of the methods herein described when the program is run on a data processing system. The data processor may be a microprocessor system, a programmable FPGA (field programmable gate array), etc.

The technology described herein also extends to a computer software carrier comprising such software which when used to operate a display controller, or microprocessor system comprising a data processor causes in conjunction with said data processor said controller or system to carry out the steps of the methods of the technology described herein. Such a computer software carrier could be a physical storage medium such as a ROM chip, CD ROM, RAM, flash memory, or disk, or could be a signal such as an electronic signal over wires, an optical signal or a radio signal such as to a satellite or the like.

It will further be appreciated that not all steps of the methods of the technology described herein need be carried out by computer software and thus, in a further broad embodiment the technology described herein provides computer software and such software installed on a computer software carrier for carrying out at least one of the steps of the methods set out herein.

The technology described herein may accordingly suitably be embodied as a computer program product for use with a computer system. Such an implementation may comprise a series of computer readable instructions either fixed on a tangible, non-transitory medium, such as a computer readable medium, for example, diskette, CDROM, ROM, RAM, flash memory, or hard disk. It could also comprise a series of computer readable instructions transmittable to a computer system, via a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrinkwrapped software, preloaded with a computer system, for example, on a system ROM or fixed disk, or distributed from a server or electronic bulletin board over a network, for example, the Internet or World Wide Web.

Embodiments of the technology described herein will now be described.

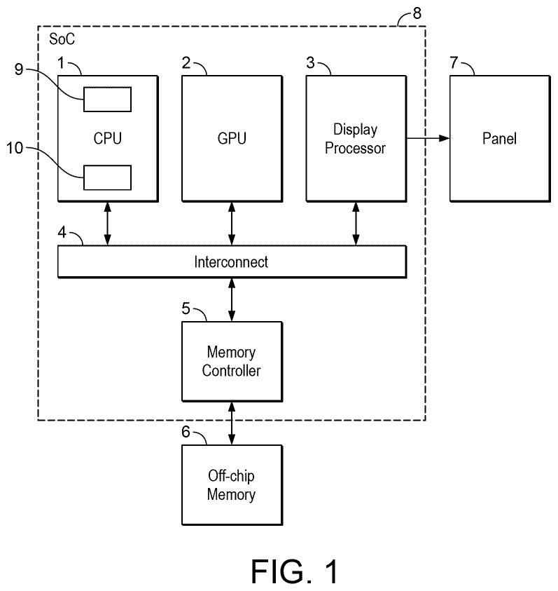

FIG. 1 shows an exemplary system on chip (SoC) graphics processing system 8 that comprises a host processor comprising a central processing unit (CPU) 1, a graphics processor (GPU) 2, a display processor 3, and a memory controller 5. As shown in FIG. 1, these units communicate via an interconnect 4 and have access to off-chip memory 6. In this system, the graphics processor 2 will render frames (images) to be displayed, and the display processor 3 will then provide the frames to a display panel 7 for display.

In use of this system, an application 9 such as a game, executing on one or more host processors (CPUs) 1 will, for example, require the display of frames on the display panel 7. To do this, the application will submit appropriate commands and data to a driver 10 for the graphics processor 2, e.g. that is executing on a CPU 1. The driver 10 will then generate appropriate commands and data to cause the graphics processor 2 to render appropriate frames for display and to store those frames in appropriate frame buffers, e.g. in the main memory 6. The display processor 3 will then read those frames into a buffer for the display from where they are then read out and displayed on the display panel 7 of the display.

In the present embodiment, the graphics processor 2 executes a graphics processing pipeline that processes graphics primitives, such as triangles, when generating an output, such as an image for display.

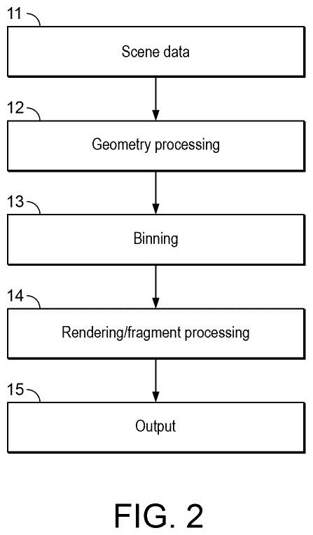

FIG. 2 shows schematically the processing sequence of the graphics processing pipeline executed by the graphics processor 2 when generating an output in the present embodiments.

FIG. 2 shows the main elements and pipeline stages. As will be appreciated by those skilled in the art there may be other elements of the graphics processor and processing pipeline that are not illustrated in FIG. 2. It should also be noted here that FIG. 2 is only schematic, and that, for example, in practice the shown pipeline stages may share significant hardware circuits, even though they are shown schematically as separate stages in FIG. 2. It will also be appreciated that each of the stages, elements and units, etc., of the processing pipeline as shown in FIG. 2 may, unless otherwise indicated, be implemented as desired and will accordingly comprise, e.g., appropriate circuitry, circuits and/or processing logic, etc., for performing the necessary operation and functions.

As shown in FIG. 2, for an output to be generated, a set of, e.g. scene data 11, including, for example, and inter alia, a set of vertices (with each vertex having one or more attributes, such as positions, colours, etc., associated with it), a set of indices referencing the vertices in the set of vertices, and primitive configuration information indicating how the vertex indices are to be assembled into primitives for processing when generating the output, is provided to the graphics processor, for example, and in an embodiment, by storing it in the memory 6 from where it can then be read by the graphics processor 2.

This scene data may be provided by the application (and/or the driver in response to commands from the application) that requires the output to be generated, and may, for example, comprise the complete set of vertices, indices, etc., for the output in question, or, e.g., respective different sets of vertices, sets of indices, etc., e.g. for respective draw calls to be processed for the output in question. Other arrangements would, of course, be possible.

There is then a geometry processing stage or stages 12, which performs appropriate geometry processing of and for the scene data to generate the data that will then be required for rendering the output. This geometry processing 12 can comprise any suitable and desired geometry processing that may be performed as part of a graphics processing pipeline.

In the present embodiments, this geometry processing comprises at least performing vertex processing (vertex shading) of attributes for vertices to be used for primitives for the render output being generated. In particular, appropriate vertex position shading is performed to transform the positions for the vertices from the, e.g. “model” space in which they are initially defined, to the, e.g., “screen”, space that the output is being generated in. In embodiments, the vertex shading also comprises generating and/or processing other, non-position attributes of vertices (varyings/varying shading). It would also be possible for some or all the varying shading to be deferred from the geometry processing and, for example, to be triggered at the binning or rendering stages instead, if desired.

As well as appropriate vertex shading, the geometry processing may comprise any other form of geometry processing that is desired, such as one or more of tessellation shading, transform feedback shading, mesh shading, or task shading. This geometry shading may also generate and/or process attributes for vertices, and/or it may process and generate attributes for primitives as well.

Once the desired geometry processing has been performed, there is then, in the present embodiments, as shown in FIG. 2, a binning/tiling stage 13. (It is assumed in this regard that the graphics processor 2 in the present embodiments is a tile-based graphics processor and so generates respective output tiles of an overall output (e.g. frame) to be generated separately to each other, with the set of tiles for the overall output then being appropriately combined to provide the final, overall output.)

The binning process operates to generate appropriate data structures for determining which primitives need to be processed for respective rendering tiles of the output being generated. For example, it may sort the primitives into appropriate primitive lists, which indicate the primitives to be processed for respective tiles or sets of tiles. Alternatively, it may generate other data structures, such as hierarchies of bounding boxes, that can then be used at the rendering/fragment processing stage to identify those primitives that need to be processed for a respective tile.

The binning/tiling process 13 may also cull primitives that are not visible (e.g. that fall outside the view frustum, and/or based on the facing direction of the primitives).

As part of the geometry processing and/or the binning/tiling operation the primitives to be processed will be “assembled”. The primitives will, as discussed above, be assembled from a set of indices referencing vertices in a set of vertices for the render output processing being performed, based on primitive configuration information indicating how the vertex indices are to be assembled into primitives for processing when generating the render output.

Such primitive assembly may be performed as part of and at an appropriate stage of the geometry processing and/or as part of the binning/tiling processing, as desired. There may also, if desired, be two (or more) “primitive assembly” operations. For example, an initial primitive assembly operation could be performed to identify those vertices that will actually be used for the render output being generated before performing any vertex shading of the vertices, but with there then being a later primitive assembly stage that provides a sequence of assembled primitives for the binning/tiling stage.

Once the binning/tiling process has generated the necessary data structures for identifying the primitives to be processed for respective tiles of the render output, the primitives can then be and are then subjected to appropriate rendering/fragment processing 14. This operation is performed in the present embodiments on a tile-by-tile basis, using the data structures generated by the tiling/binning process 13 to identify those primitives that need to be processed for a respective tile.

The rendering/fragment processing can comprise any suitable and desired rendering and fragment processing operations that may be performed. Thus it may comprise, for example, first rasterising primitives to be processed for a tile to fragments, and then processing those fragments accordingly (e.g., and in an embodiment, by performing appropriate fragment shading of the fragments). The rendering/fragment processing may also or instead comprise performing ray tracing operations, such as performing the rendering by tracing rays for respective fragments representing respective sets of one or more sampling positions of the output being generated. Hybrid ray tracing operations would also be possible, if desired.

The output of the rendering/fragment processing (the rendered fragments) is written to a tile buffer (not shown). Once the processing for the tile in question has been completed, then the tile will be written to an output data array in memory 6, and the next tile processed, and so on, until the complete output data array 15 has been generated. The process will then move on to the next output data array (e.g. frame), and so on.

The output data array may typically be an image for a frame intended for display on a display device, such as a screen or printer, but may also, for example, comprise intermediate render data intended for use in later rendering passes (also known as a “render to texture” output), or for deferred rendering, or for hybrid ray tracing, etc.

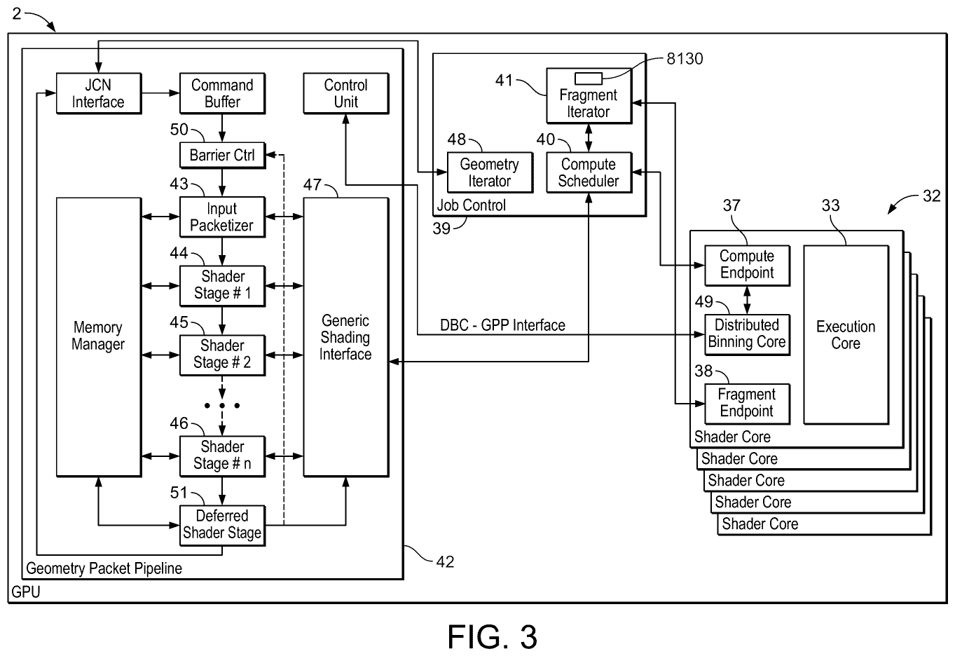

FIG. 3 shows an embodiment of a graphics processor (GPU) 2 that can execute a graphics processing pipeline of the form shown in FIG. 2, and that can be operated in the manner of the technology described herein.

As shown in FIG. 3, the graphics processor 2 comprises a plurality of processing (shader) cores 32 which are each operable to execute (shader) programs to perform processing operations. As shown in FIG. 3 each shader core 32 to facilitate this comprises a programmable execution unit (execution core) 33 that is operable to execute program instructions to perform processing operations.

In the present embodiments, the shader cores 32 are operable to execute both “compute” shader programs (to perform so-called compute shading) and fragment shader operations. Thus as shown in FIG. 3, each shader core 32 comprises an appropriate compute endpoint 37 and fragment endpoint 38 that act as the control interface for performing compute shading and fragment processing, respectively, and that will, for example, and in an embodiment, trigger the execution core 33 to execute the appropriate compute shading or fragment shading tasks, as required.

As shown in FIG. 3, the compute endpoint 37 and fragment endpoint 38 receive appropriate processing tasks from a job control unit 39 of the graphics processor 2, which job control unit 39 includes an appropriate compute scheduler 40 and fragment iterator 41 for distributing processing jobs that the job controller 39 receives as appropriate processing jobs to the shader cores 32.

As discussed above, when performing graphics processing, there will typically be an initial geometry processing stage that determines the vertex and other data that is necessary for generating the graphics processing output in question, which will then be followed by a rendering/fragment processing stage for processing (rendering) that geometry.

In the present embodiments, the geometry processing is performed, as shown in FIG. 3, by a geometry packet pipeline 42 of the graphics processor 2. This geometry packet pipeline is operable to trigger the performance of one or more “geometry” shader stages (which shader stages themselves will be executed by the shader cores 32, under the control of the geometry packet pipeline 42).

For example, as shown in FIG. 3, the geometry packet pipeline 42 comprises an input packetizer 43 that can trigger position shading and vertex shading by the shader cores 32. It also includes further shader stage circuits 44, 45, 46 that are operable to trigger compute shaders for performing geometry processing, such as task shaders, mesh shaders, tessellation shaders, etc. (which again will be executed by the shader cores 32).

As shown in FIG. 3, the geometry packet pipeline 42 has an appropriate interface 47 to the compute scheduler 40 of the job control unit 39, via which it can control and trigger the performance of appropriate geometry shading operations by the shader cores 32.

As shown in FIG. 3, the geometry packet pipeline 42 also includes a “barrier” control unit (circuit) 50 at the beginning of the pipeline and a “deferred shader stage” control unit (circuit) 51 at the end of the pipeline. The operation of these elements will be described in more detail below.

The overall operation of the geometry packet pipeline 42 is controlled by the job control unit 39 (by a geometry iterator 48 of the job control unit 39) which distributes the appropriate geometry processing jobs and tasks to the geometry packet pipeline 42.

The graphics processor 2 of FIG. 3 is configured to perform rendering in a tile-based manner (as discussed above). To facilitate this, as shown in FIG. 3, each shader core 32 also includes a distributed binning core 49 that is operable to generate appropriate data structures for determining which primitives need to be processed for respective rendering tiles of the output being generated.

In the present embodiments, the distributed binning cores 49 generate hierarchies of bounding boxes for primitives and primitive packets (that contain primitives to be rendered) (which are then used at the rendering/fragment processing stage to identify those primitives that need to be processed for a respective tile).

The distributed binning cores 49 may also cull primitives that are not visible (e.g. that fall outside the view frustum, and/or based on the facing direction of the primitives).

The distributed binning cores 49 can operate in any suitable and desired manner for this purpose.

The distributed binning cores 49 of the shader cores 32 may trigger vertex shading, such as varying shading, as part of their operation (e.g. where varying shading was not performed by the input packetizer as part of the input packetizer 43 operation).

In the present embodiments, the rendering/fragment processing is performed by executing appropriate fragment processing operations on a shader core 32 under the control of the fragment endpoint 38. To facilitate this, the fragment endpoint 38 of each shader core is operable to trigger appropriate fragment shader operation by a shader core.

As will be appreciated from the above, in operation of the present embodiments, the geometry packet pipeline 42 that performs the geometry processing will generate appropriate geometry data, such as (transformed) vertex positions, vertex varyings, and primitive attributes, which data will then be used, for example, by the binning/tiling processing and rendering/fragment processing of the later stages of the graphics processing pipeline.

In the present embodiments, the geometry packet pipeline 42 operates to generate respective geometry packets containing the data that it generates. In the present embodiments, those geometry packets are then processed by the distributed binning cores 49 to generate corresponding primitive packets, which primitive packets are then used by the fragment processing (fragment shaders) 52.

Thus, in the present embodiments, the geometry packet pipeline 42 will generate geometry packets that store attributes for vertices and primitives, which geometry packets will then be read and used by the distributed binning cores 49.

Correspondingly, the distributed binning cores 49 will generate appropriate primitive packets storing attributes for vertices and primitives, which primitive packets will then be read and used by the fragment processing 38.

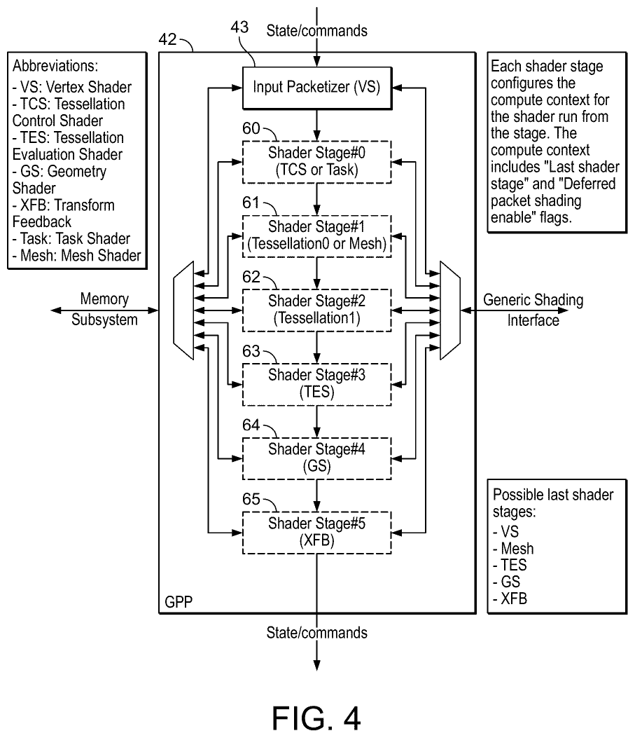

FIG. 4 shows the geometry packet pipeline 42 of the present embodiments in more detail.

As shown in FIG. 4, in the present embodiments the geometry packet pipeline 42 comprises (can trigger the execution of) (up to) six shader stages, an input packetizer 43 (that can trigger vertex shading (VS)); a next shader stage 60 that can trigger tessellation control shading or task shading; a next shader stage 61 that can trigger tessellation shading or mesh shading; a next shader stage 62 that can trigger further tessellation shading; a next shader stage 63 that can trigger tessellation evaluation shading; a next shader stage 64 that can trigger geometry shading; and a final shader stage 65, that can trigger transform feedback shading.

In the present embodiments, when executing the geometry packet pipeline for a render output (e.g. for a draw call), the various shader stages shown in FIG. 4 can be selectively enabled. In other words, not every execution of the geometry packet pipeline 42 will include all the shader stages shown in FIG. 4, but selective shader stages can be omitted from the geometry packet pipeline 42 that is being executed.

In any event, and irrespective of any preceding shader stages that are activated, in the present embodiments, the shader stages that can potentially be the last shader stage of any given geometry processing pipeline are the vertex shader (input packetizer 43); the mesh shader (shader stage 61), the tessellation evaluation shader (stage 63), the geometry shader (stage 64) and the transform feedback shader (stage 65).

One of these shader stages will always be the last shader stage in a given geometry packet pipeline that is being executed in the embodiments of the technology described herein. (Any shader stages that are omitted in the geometry packet pipeline actually being executed are disabled, so that packets will, in effect, simply pass through those stages without being processed.)

In operation, each shader stage of the geometry packet pipeline 42 will configure the compute context for the shader that is run from the stage in question. In the present embodiments, the compute context that is configured for a (and each) shader stage includes an indication of whether the shader stage in question is the last shader stage for the geometry processing pipeline being executed, and whether “deferred packet shading” has been enabled or not. In the present embodiments, the compute context for each shader stage includes appropriate flags that can be set to indicate this.

In the present embodiments, the first, input packetizer stage 43 of the geometry pipeline 42 of the present embodiments generates respective initial geometry packets storing data for sets of primitives to be processed for the render output being generated.

To do this, the input packetizer 43 assembles primitives using lists of vertex indices indicating vertices to be used to assemble primitives for the render output being generated based on appropriate primitive configuration information indicating how the lists of vertices should be assembled into primitives, and then assigns the assembled primitives to packets in order. In the present embodiments, a packet has a fixed capacity, e.g. an upper limit of vertices and/or primitives, and when the fixed capacity is reached, a new packet is started. Appropriate memory space for storing a packet is also allocated.

The (geometry) packets generated by the input packetizer 43 are then passed to the next (enabled) shader stage (if any) for processing, with that shader stage then performing appropriate processing of the packets that it receives and generating corresponding output packets, which are then passed on to the next shader stage of the geometry packet pipeline 42 (if any), and so on, until the final shading stage of the geometry packet pipeline being executed is reached (which as discussed above will be indicated as such).

In the present embodiments, when the last shader stage of the geometry packet pipeline being executed is reached for a packet, a packet shading request is sent for the last shader of the geometry packet pipeline to be executed for the packet, but rather than the last shader of the geometry packet pipeline being executed simply being executed on the shader cores 32 for the packet, the packet is instead first processed by a distributed binning core 49 of a shader core.

In particular, the “last” shader stage packet shading request for a packet is sent to the compute endpoint 37 of the shader core 32 in question which then signals the distributed binning core 49 accordingly.

The distributed binning core 49 then determines whether to defer the final shader stage of the geometry packet pipeline for the packet, or perform that last shader stage of the geometry packet pipeline being executed for the packet immediately.

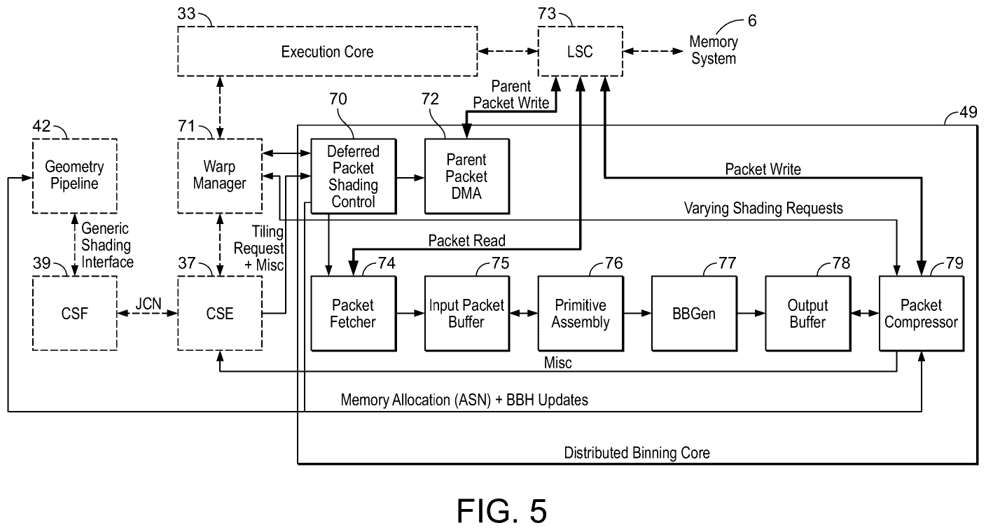

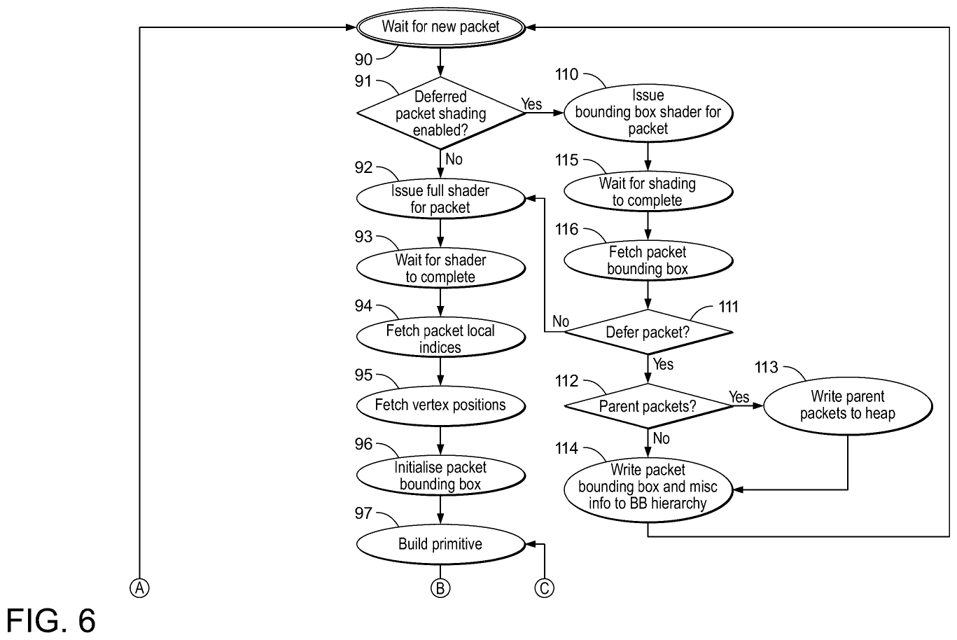

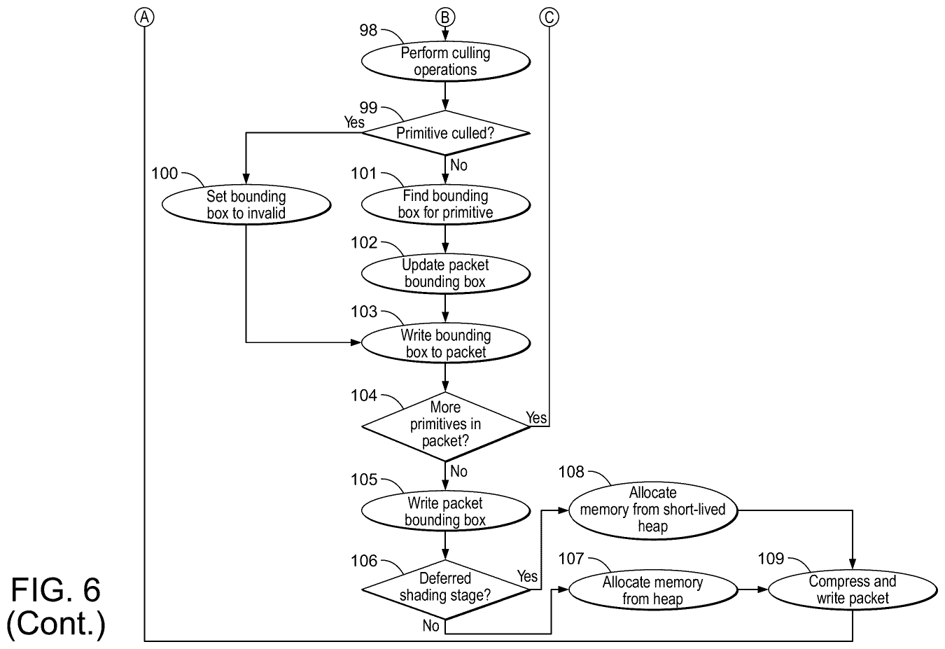

FIGS. 5 and 6 show the operation of a distributed binning core 49 in this regard in the present embodiments. FIG. 5 is a block view of a distributed binning core 49 showing elements of that core that are relevant to this operation. FIG. 6 is a flow chart showing the distributed binning core operation in the present embodiments.

As shown in FIG. 5, the distributed binning core includes a deferred packet shading control unit/circuit 70 that receives appropriate processing requests from the compute shader endpoint 37 when a last shader stage is to be executed for a packet.

As will be discussed further below, the deferred packet shading control 70 determines whether the last shading stage for the packet should be deferred or not, and then either triggers the shading for the packet, or defers that shading, accordingly. As shown in FIG. 5, to facilitate this, the deferred packet shading control unit 70 has an appropriate interface to a warp manager 71 for issuing shading processing to its associated execution core 33.

The deferred packet shading control unit 70 also controls a “parent packet” DMA unit 72 that is operable to write the “parent” packet (i.e. the geometry packet that is still to undergo its last shading stage) to memory (via, for example, a load store cache 73 of the shader core) in the case where the last shading stage is deferred (as if the last shading stage is deferred, the “parent” packet for that shading stage will be required for executing that shading stage later on in the processing (in a deferred manner)).

As shown in FIG. 5, the distributed binning core includes an appropriate packet processing pipeline 49, which is used to generate appropriate primitive packets for processing by the rendering/fragment processing from the geometry packets that it receives, and to also generate the appropriate data structures (which in the present embodiments are hierarchies of bounding boxes for packets) to allow the rendering/fragment processing to determine which packets need to be processed for a given rendering tile.

Thus as shown in FIG. 5, the distributed binning core packet processing pipeline comprises a packet fetcher 74 which is operable to fetch packets to be processed from the memory, and an input packet buffer 75 for buffering the packets while they are processed. A primitive assembly stage (circuit 76) is operable to assemble primitives in packets and, where appropriate, perform culling operations for the primitives. The assembled primitives (that are not culled) are then passed to a bounding box generation stage/circuit 77, with the processed primitives, etc., then being stored in an output buffer 78 until the relevant primitive packet is completed (at which point the packet will be compressed 79 and then written out to memory).

As shown in FIG. 5, the distributed binning core can also trigger vertex varying shading for vertices in a packet, if required, for example where that has not been performed as part of the geometry packet pipeline execution.

FIG. 6 shows the operation of the distributed binning core 49 when a packet shading request for the last shader of the geometry packet pipeline being executed is received for a packet.

As shown in FIG. 6, when such a shading request for a packet is received (step 90), it will first be determined whether deferred packet shading has been enabled (step 91).

If deferred packet shading has not been enabled then the last shading stage of the geometry packet pipeline being executed will be performed immediately (triggered by the deferred packet shading control 70 of the distributed binning core).

Thus in this case, the full shader (the last shading stage for the geometry packet pipeline) will be issued and executed (step 92) for the packet in question. Then, once that shading has been completed (step 93), the distributing binning core will process the “finished” geometry packet to derive a bounding box for the packet and for the primitives in the packet and to cull any primitives in the packet that can be culled, etc.

For this processing, as shown in FIG. 6, first the indices for the vertices in the (completely geometry processed) geometry packet will be fetched (step 94). The vertex positions for the vertices in the packet will correspondingly be fetched (step 95), and a bounding box for the packet initialised (step 96).

The process will then build each primitive in the packet (step 97) in turn, and determine if the primitive can be culled (step 98). If a primitive is culled (step 99), then the bounding box for the primitive is set to be invalid (step 100) (to indicate that the primitive has been culled), and that (invalid) bounding box is written to the primitive packet accordingly (step 103).

On the other hand, if the primitive is not culled (step 99), then a bounding box for the primitive is determined (step 101). The bounding box for the packet is updated based on the primitive bounding box (step 102), and the bounding box for the primitive is written to the packet (step 103).

If there are more primitives in the packet, then the process is repeated until all the primitives for the packet have been processed (step 104).

Once all the primitives in the packet have been processed, then the overall bounding box for the packet is written to the packet bounding box hierarchy, as appropriate (step 105). The packet itself is then compressed and written out to memory (step 109).

As shown in FIG. 6, and as will be discussed in more detail below, in the case where the last stage of geometry shading for a packet is not being deferred (so is being performed immediately) then the packet is compressed and written to a “long-term” heap in memory (steps 106 and 107).

As shown in FIG. 6, in the case where deferred packet shading is enabled at step 91, then the process first determines a bounding box for the packet in question.

This packet bounding box can be determined in any suitable and desired manner.

This may, as discussed above, be based on and use information provided by the application that is requesting the graphics processing, and/or use appropriate position information for the packet from preceding geometry processing stages that have been performed for the packet, and/or be determined by executing an appropriate position shading (bounding box shader) for the packet that determines a bounding box for the packet (but does not otherwise perform any geometry processing, e.g. that is to be deferred for the packet).

In the case where the bounding box for a packet is then determined by running a bounding box shader for the packet (as shown in FIG. 6), the distributed binning core will issue the bounding box shader (step 110) and wait for the shading to be complete (step 115), and then fetch the packet bounding box that has been generated as a result of the bounding box shader (step 116).

Thus, if necessary, the deferred packet shading control triggers a process to appropriately generate a bounding box for a packet (and then fetches the bounding box for the packet). Alternatively, where the bounding box for the packet is already available, it will simply fetch the bounding box for the packet.

The deferred packet shading control 70 will then determine whether to defer the final geometry packet pipeline shading stage for the packet or not (step 111). In the present embodiment, this decision is based on a count of how many packets have already been deferred for the render output in question. Other arrangements would, of course, be possible.

As shown in FIG. 6, in the case that it is decided not to defer the final geometry packet pipeline shading stage for the packet at step 111, then the full shader is issued for the packet at step 92 and the process discussed above is followed for the packet.

On the other hand, when it is decided to defer the final geometry packet pipeline shading stage for the packet, it is then determined whether the packet whose processing is being deferred has any relevant parent packets that would be needed when performing the deferred processing (step 112). If so, the deferred packet shading control 70 causes the required parent packets to be written appropriately to memory (step 113).

As shown in FIG. 6, the distributed binning core operation will then write the packet bounding box and any other information (e.g. state) required for performing the deferred packet shading at a later time into the bounding box hierarchy structure that it is generating for the render output in question (step 114).

The process then waits for the next packet to be processed (step 90), and so on.

Once all the packets for a render output (e.g. draw call) being processed have reached the last stage of the geometry processing pipeline being executed and correspondingly being processed by a distributed binning core in the manner illustrated in FIG. 6, then the distributed binning core(s) will have generated, between them, an appropriate binning data structure or structures that can be used to determine which packets for the render output should be processed for respective rendering tiles of the render output.

In the present embodiments, the binning data structures generated by the distributed binning cores comprise appropriate bounding box hierarchies, against which respective rendering tiles can be tested to determine whether a packet should be processed for the rendering tile or not.

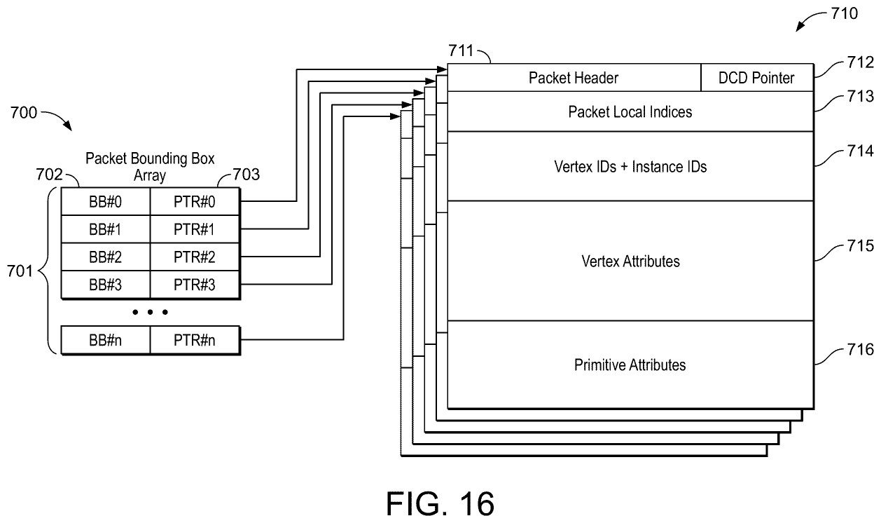

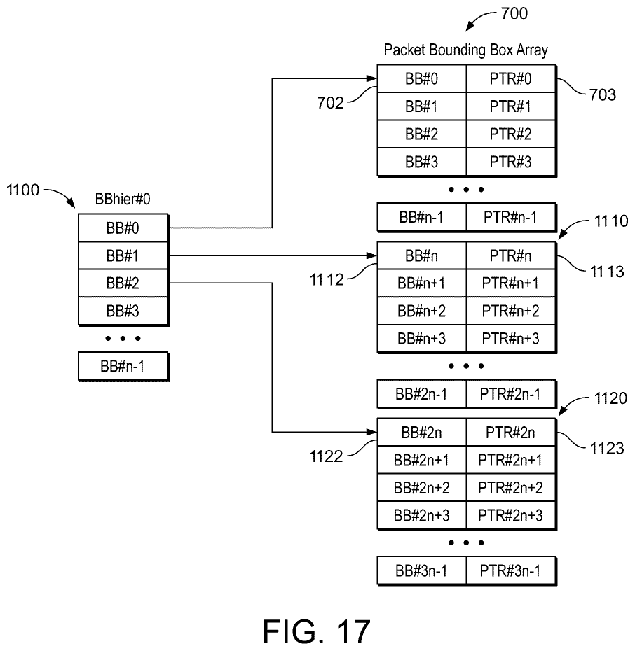

FIGS. 16 and 17, show, by way of example, a bounding box hierarchy binning data structure that may be generated in the present embodiments, in the case where all the geometry processing for all of the packets for the render output in question is (fully) completed prior to the binning stage (prior to the binning data structures being generated).

As shown in FIG. 16, the lowest level of the bounding box hierarchy comprises a packet bounding box array 700 that includes a number of entries 701 that each include a respective pointer 703 pointing to the respective packet 710 in memory, and a bounding box (bounding box information) 702 for the packet in question.

FIG. 16 also shows the memory layout and content for an exemplary packet 710 that may have been generated. As illustrated in FIG. 16, in the present embodiments, each packet 710 may include header information 711 that includes a pointer to the draw call descriptor (DCD) 712 for the draw call that the packet represents. Each packet 710 further includes body information comprising identifiers 714 for the vertices that the packet contains, and indices 713 that reference the vertices to define the primitives that the packet contains. Each packet 710 further includes vertex attribute data 715 for the vertices that the packet contains, and primitive attribute data 716 for the primitives that the packet contains.

A packet 710 may also comprise respective primitive bounding boxes for primitives contained within the packet (where they have been generated by the binning process).

Other arrangements of packet would, of course, be possible.

As shown in FIG. 17 one or more further bounding box hierarchy levels are also generated.

As illustrated in FIG. 17, a bounding box hierarchy array 1100 may be maintained, with each entry of the array comprising a pointer pointing to an array defining bounding boxes for a respective level of the bounding box hierarchy. As illustrated in FIG. 17, in this embodiment, the first entry of the bounding box hierarchy array 1100 points to the lowest level packet array 700 shown in FIG. 16.

A higher level of the bounding box hierarchy may be generated by iterating through the packet array 700 and generating from the packet bounding boxes 702, bounding boxes for groups of, e.g. two, four, eight (or another number), packets. As illustrated in FIG. 17, these (larger) bounding boxes may be stored in entries of higher-level array 1110, wherein each entry of the array 1110 comprises a respective, “higher level” bounding box 1112, and pointers 1113 pointing to the packet array 700 entries for the packet bounding boxes from which the “higher level” bounding box was generated.

Further levels of the bounding box hierarchy may be generated in an analogous manner. For example, FIG. 17 shows a higher-still level of the bounding box hierarchy generated by iterating through array 1110 and generating from the bounding boxes 1112, larger bounding boxes, which are stored in entries of array 1120, wherein each entry of the array 1120 comprises a respective, higher level bounding box 1122, and pointers 1123 pointing to the corresponding next lower level array 1110 entries. Further levels of the bounding box hierarchy may be generated up to a “highest” level which may comprise a single bounding box that encompasses all primitives of all packets, e.g. for the draw call/render output in question.

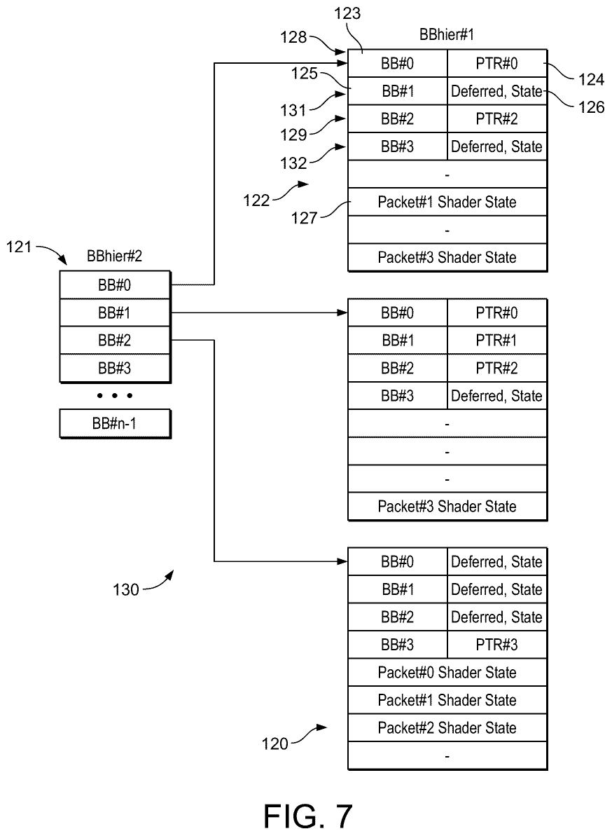

FIG. 7 shows a corresponding binning data structure 130 in the form of a bounding box hierarchy for use to determine which packets should be processed for respective rendering tiles that is generated by the distributing binning cores 49 in the present embodiments in the case where the last geometry shader stage has been deferred for some packets (so including “primitive” packets for which the geometry packet pipeline has been fully executed, and “geometry” packets for which the last stage of the geometry packet pipeline has been deferred).

As shown in FIG. 7, the bounding box hierarchy in this example includes two levels, a lower level 120 that stores bounding boxes for respective individual primitive packets, and a higher level 121 that stores bounding boxes for respective groups of primitive packets.

Thus, when using this data structure to identify primitive packets that should be processed for a rendering tile, the tile will first be tested against the higher level bounding boxes 121 to determine respective groups of primitives that (potentially) need to be processed for the tile. Then the tile will be tested against the respective individual packet bounding boxes in the appropriate lower level 120 data structure to identify those primitive packets that should be processed for the tile.

As shown in FIG. 7, the lower level bounding box hierarchy 120 stores in the case of a primitive packet for which the last stage of the geometry packet pipeline was not deferred, a bounding box 123 for the primitive packet, and a pointer 124 to where the primitive packet is stored in memory.

On the other hand, for a primitive packet whose last stage in the geometry packet pipeline was deferred, the lower level 120 of the bounding box hierarchy instead stores a bounding box 125 for the primitive packet, together with an indication 126 that the last stage of the geometry packet pipeline for that packet has been deferred, and any appropriate state, etc., 126, 127 that is required for performing the deferred shading.

Thus, as shown in FIG. 7, for a first group of four primitive packets 122, for the first and third primitive packets 128, 129 in that group, for which all of the geometry packet pipeline shading has been completed, an appropriate bounding box and a pointer to the packet in memory is stored in the binning data structure 130.

On the other hand, the second and fourth primitive packets 131, 132 have had the last stage of the geometry packet pipeline shading deferred, and so for those packets, a bounding box and an indication that the shading has been deferred, together with the appropriate shader state for performing the deferred shading, is stored.

Once the necessary binning data structures for the render output (e.g. draw call) being processed have been generated by the distributed binning cores, then the rendering/fragment processing of the render output in question can be performed.

In the present embodiments, the rendering/fragment processing is triggered and controlled by the fragment iterator 41 issuing appropriate fragment shading (rendering) tasks to the fragment endpoints 38 of the shader cores, with the fragment endpoints then triggering appropriate fragment shading etc., on the execution cores, accordingly.

In the present embodiments, the triggering and control of the rendering/fragment shading by the fragment iterator is also operable to determine whether any geometry shading has been deferred for packets to be processed for tiles, and to, if so, trigger the performance of the deferred geometry processing for a packet, before the rendering/fragment processing for a tile using the packet is performed.

To facilitate this, in the present embodiments, the fragment iterator includes a deferred shading control unit (circuit) 8130, that receives appropriate commands (run_fragment) commands to perform rendering/fragment processing for a render output, and which in response to those commands, determines whether deferred geometry shading has been enabled, and if so, then determines whether any deferred geometry shading for packets for a render output needs to be performed before rendering/fragment shading is performed.

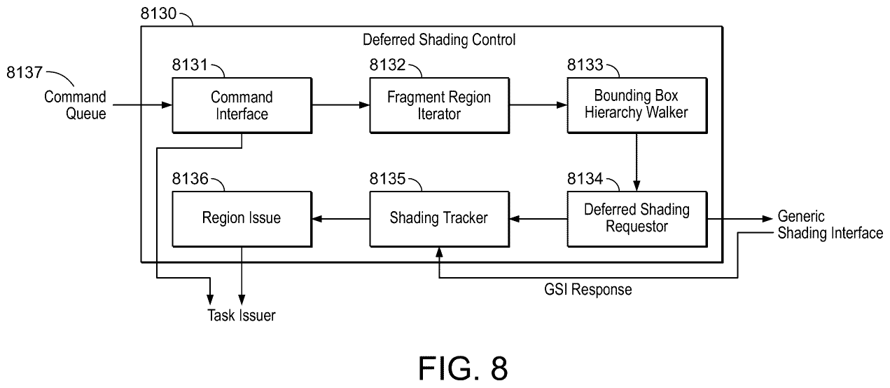

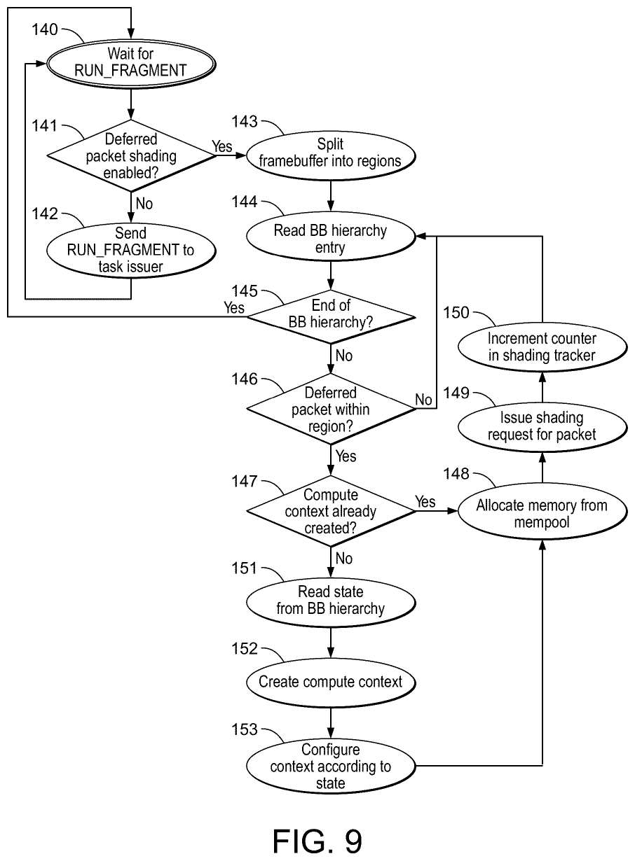

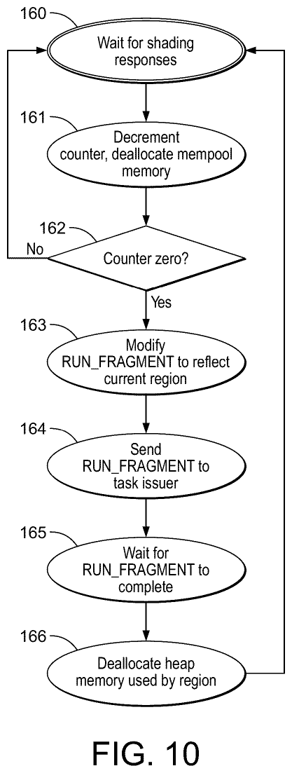

FIG. 8 shows the deferred shading control unit 8130 of the present embodiments in more detail. FIGS. 9 and 10 are corresponding flowcharts showing the operation of the deferred shading control unit of the present embodiments.

As shown in FIG. 8, the deferred shading control unit 8130 includes a command interface 8131 that receives appropriate rendering/fragment shading commands from a command queue 8137.

When the command interface 8131 receives a run_fragment command (thereby indicating that fragment shading for a render output should be performed) (step 140, FIG. 9), the command interface 8131 (FIG. 8) first determines whether deferred packet (geometry) shading has been enabled (step 141, FIG. 9).

In the event that deferred packet shading has not been enabled, then the command interface simply sends the run_fragment command directly to a task issuer that generates the appropriate tasks for sending to the fragment endpoints 38 of the shader cores 32 to perform the necessary fragment shading to generate the render output (step 142, FIG. 9).

On the other hand, in the event that deferred geometry shading for packets has been enabled, then the command interface 131 signals a fragment iterator 8132 (FIG. 8) to that effect. The fragment region iterator 8132 divides the render output into respective regions (areas) for processing (step 143, FIG. 9).

In particular, the fragment region iterator 8132 operates to scan through the binning data structures (the bounding box hierarchy) for the render output being generated, to determine information of how the rendering (fragment shading) can be performed for the render output in question with the aim of avoiding needing to store any data generated when performing deferred geometry processing for packets for a region to external memory. Thus the fragment region iterator 8132 attempts to divide the render output (frame) into smaller regions, such that the (estimated/predicted) amount of deferred geometry shading data will not exceed the (local) storage capacity of the graphics processor. (This said, the overall process does still include some mechanism for allowing data to be “spilled” to external memory if required.)

Each region may comprise a single rendering tile, but in an embodiment comprises plural (contiguous) rendering tiles.

Once the render output (frame) region partitioning is decided, the fragment region iterator 8132 selects a region for processing and signals a bounding box hierarchy walker 8133 to walk the binning bounding box hierarchy to identify any packets for the region for which the geometry processing has been deferred.

The bounding box hierarchy walker (walking circuit) 8133 (FIG. 8) traverses the bounding box hierarchy binning data structure generated by the distributed binning cores to determine those geometry/primitive packets that apply to the render output region in question and whether any of those packets have had their geometry processing deferred (steps 144, 145 and 146 in FIG. 9).

When a packet applying to a region for which the geometry processing has been deferred is identified at step 146, the appropriate geometry processing for that packet is triggered by a deferred shading requester circuit 8134 (see FIG. 8) of the deferred shading control unit 8130. (For any packets applying to the region for which geometry processing has been deferred, the appropriate deferred shading operation is triggered (issued) by the deferred shading requester 134.)

When deferred geometry processing for the packet is to be performed, as shown in FIG. 9 it is first determined whether the appropriate compute shading context has already been created (step 147).

If so, an appropriate memory allocation is allocated for the result of the geometry processing of the packet (step 148), the appropriate geometry shading request for the packet is issued (step 149) and a counter in a geometry processing shading tracker 8135 is incremented (step 150) (this counter is used to track and determine when all the packets within the region being considered have had their deferred geometry processing completed).

In the case where the compute context for the deferred geometry shading has not already been created (step 147), then the appropriate compute shading state is read from the bounding box hierarchy binning data structure (step 151), the appropriate compute shading context is created (step 152), and configured according to the read state for the packet in question (step 153).

Then, again, appropriate memory is allocated, a shading request for the packet is issued, and the shading tracker counter is incremented (steps 148, 149 and 150).

In the present embodiments, the deferred geometry shading for a packet is triggered and controlled by sending a shading request for the packet to the distributed binning control of a shader core, for the distributed binning core of the shader core to then trigger the deferred geometry shading for the packet in question and then generate an appropriate processed packet and updated binning data structure (bounding box hierarchy) for the processed (and shaded) packet. This operation is performed in the manner discussed above with reference to FIG. 6 (in the case where deferred packet shading is not enabled at step 91).

Thus, in this case, when the packet for which deferred geometry shading is to be performed is sent to a distributed binning core at the rendering stage, the distributed binning core will first issue the deferred geometry shading for the packet (step 92), and then when that shading is complete (step 93) process the packet in the manner discussed above with reference to FIG. 6 to generate the appropriate primitive packet (steps 94-105) and update the corresponding binning data structure (bounding box hierarchy) accordingly. The binning stage also in an embodiment correspondingly sets the packet as not (no longer) having any geometry processing “deferred” for it in the updated binning structure, so that when the updated binning structure is used, the packet will be seen as being “complete”, and not needing further geometry processing to be performed for it (as that further geometry processing will now have been done).

As shown in FIG. 6, in this case, as the processing is being performed at the deferred shading point (step 106), the processed packet that has been generated by the distributed binning core after the deferred shading has been performed is stored in a “short-lived” heap in memory (steps 108 and 109) (rather than being stored in a longer-term memory heap).

As shown in FIG. 9, the process then continues to read further entries in the bounding box hierarchy binning data structure to identify all packets in the region for which geometry processing has been deferred and to trigger that geometry processing appropriately.

A shading tracker (circuit) 8135 for the deferred shading control unit 8130 maintains appropriate counters to track the packets for which deferred geometry shading is being performed for a region, and to correspondingly track when all the deferred geometry processing of packets for the region has been completed. To facilitate this, as shown in FIG. 8, the shading tracker 8135 will receive responses from the shader cores indicating when the deferred geometry processing for a packet has been completed, so that it can then decrement the corresponding region counter.

Once a deferred geometry shading counter for a region has been decremented to 0, that is taken as indicating that the geometry processing for all the deferred packets in the region has been completed, such that the geometry processing will then have been completed for all the packets for the region in question, such that the fragment processing (rendering) for the region can proceed. This is signalled to an appropriate region issue circuit 8136 (FIG. 8), which issues an appropriate “region” run_fragment command to the task issuer for the task issuer to issue appropriate fragment processing tasks for the region in question.

FIG. 10 illustrates this operation and shows that in response to geometry shading completion responses received from the shader cores, the shading tracker 8135 will decrement the appropriate region deferred geometry shading tracking counter (steps 160, 161) and when the counter for a region is 0 (step 162) generate a “modified” run_fragment command for the region in question (step 163) and send that “modified” run_fragment command to the task issuer (step 164). Then, once the fragment shading for the region has been completed (step 165), the memory allocation used for the region in question will be deallocated (step 166).

This process will be repeated each time the deferred geometry shading for packets for a render output region has been completed, so as to trigger the appropriate fragment shading for each respective region that the render output has been divided into.

Although the present embodiments show the deferred shading control unit 8130 as being part of the fragment iterator in the job control unit 39, that deferred shading control unit and process can be located and performed elsewhere in the graphics processor, if desired. For example, it could be part of (e.g. at the end of) the geometry packet pipeline, if desired.

Once an appropriate run fragment command has been sent to the task issuer, the task issuer will then issue appropriate rendering/fragment processing tasks to the fragment endpoints 38 of the shader cores 32 for respective rendering tiles accordingly.

The tasks will indicate an appropriate set of one or more tiles to be rendered by the shader core in question, together with an indication of the rendering/fragment processing that is to be performed for the tiles. The fragment endpoint 38 will then use the binning data structures generated by the distributed binning cores to identify the packets and primitives to be processed for a tile that they are processing, and perform appropriate rendering/fragment processing for the primitives in question for the tile in question.

The rendering/fragment processing that is performed for primitives and for a tile can comprise any suitable and desired rendering/fragment processing that can be performed, such as rasterising primitives to fragments and then performing fragment shading for the fragments, and/or performing ray tracing operations, etc.

Once a shader core has processed a tile, that tile will be written out to memory and the shader core will process the next tile (if any) that it is to process, and so on. This will be continued until the render output in question has been entirely generated.

This process will then be repeated for the next render output, and so on.

As discussed above with reference to FIG. 6, for example, in the present embodiments, the memory heap that is used for storing the packets that have been processed in the technology described herein is configured and used as two separate “sub-heaps”, one heap that is used to store packets that need to be retained for a longer period of time, and another heap that is used to store packets that need to be retained for a shorter period of time.

In particular, as discussed above, any packets that are generated as a result of performing deferred geometry processing at the rendering stage are, preferentially, stored in a “short-lived” heap, which is allocated and used while processing a given render output region. Thus there will be a short-lived heap that is allocated for a region and used for storing any newly generated packets when performing deferred geometry shading for packets in the region, but which short-lived heap is then de-allocated once rendering (fragment shading) for the region in question has been completed.

Thus this short-lived heap will be allocated and used on a region-by-region basis. (When de-allocating a short-lived heap when the rendering (fragment shading) for a region has been completed, the data may also be invalidated at that point to prevent old data from spilling into external memory, if desired.)

The other, longer-lived memory heap is in an embodiment allocated and used for a given render output being processed, and thus will be allocated and de-allocated on a per render output basis. Thus this heap will remain valid and in use whilst all of the regions for the render output in question are being processed (and will be de-allocated when the last region for the render output in question has been processed). (To facilitate this, if appropriate, the “long-lived” and “short-lived” sub-heaps can be merged when the last region for a render output is being processed, to assist de-allocating all the memory allocation that has been used by the render output, if desired.)

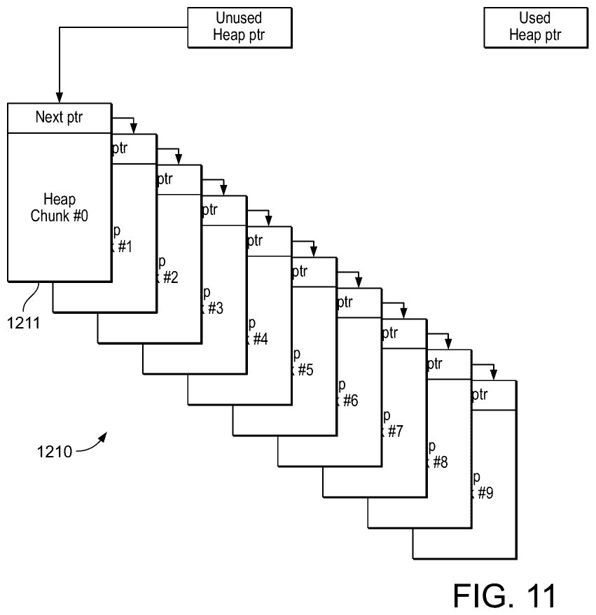

FIGS. 11-14 illustrate this.

As shown in FIG. 11, the memory heap 1210 that will be used for storing the packets in the present embodiments is organised as an appropriately linked sequence of heap “chunks” 1211. When a memory allocation for storing packets is required, then appropriate allocation of heap chunks will be requested.

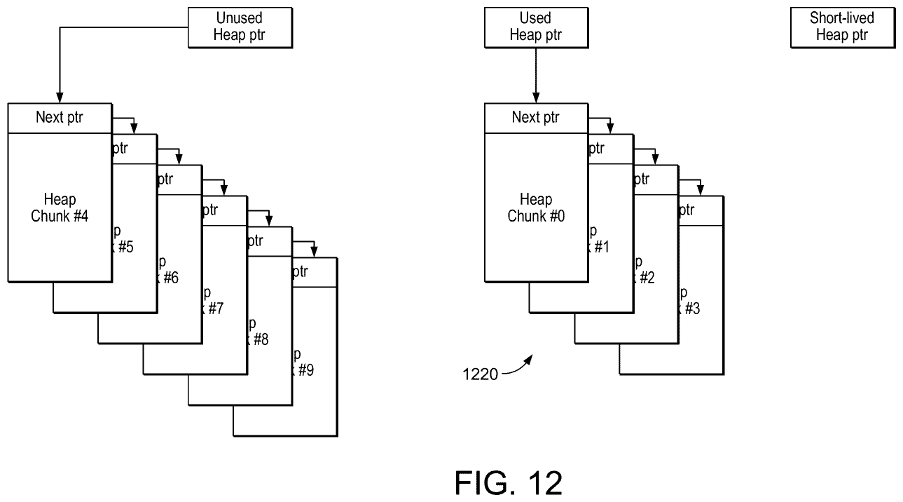

As shown in FIG. 12, when performing the initial (not-deferred) geometry processing, appropriate heap chunks will be allocated to a “long-lived” heap 1220 for storing the packets that are generated by the geometry processing pipeline. These packets and heap chunks will remain valid and in use until the rendering for the render output in question has finished. Thus the “long-lived” heap 1220 will be used to store primitive packets for which the geometry processing and binning processing has been completed at the binning stage, together with the appropriate bounding box hierarchy binning data structure or structures. Any “input” packets that are required for performing any deferred geometry processing are also stored in the “long-lived” heap.

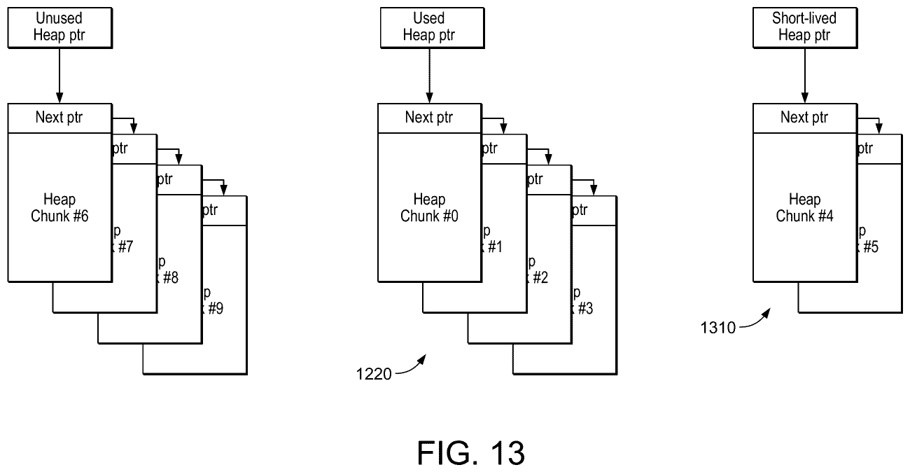

As shown in FIG. 13, when deferred geometry processing is being performed at the rendering stage, appropriate heap chunks will be allocated for storing the processed packets from that geometry processing in a “short-lived” heap 1310, which will be de-allocated once the rendering for the render output region in question has been completed.

Once the rendering (fragment processing) of a region has been completed, the heap chunks in the short-lived heap 1310 are de-allocated and circulated back to the unused heap chunks for re-use.

Once the entire render output has been completed, then the heap chunks in the “long-lived” heap 1220 are de-allocated and circulated back to the unused heap chunks for reuse.

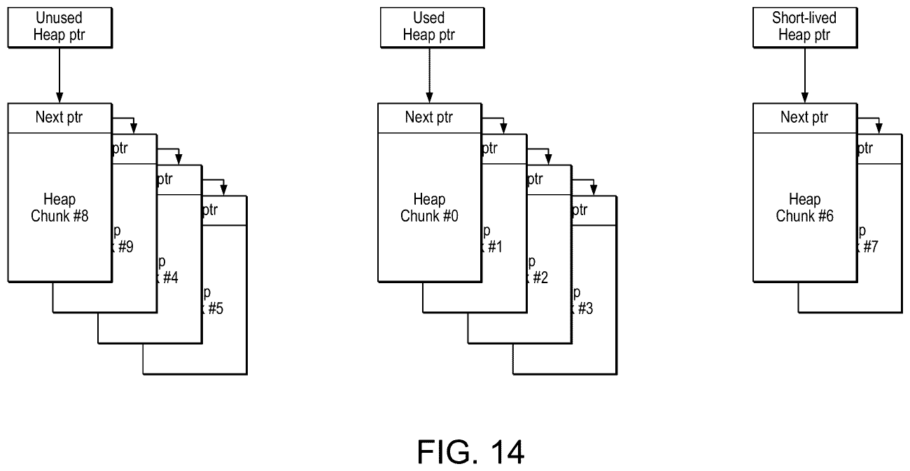

FIG. 14 illustrates this and shows, for example, the heap usage for a next region being processed. Thus in this case, the heap chunks in the short-lived heap for the previous region have been returned to the unused heap chunks for reuse, and new heap chunks have been assigned to a short-lived heap for use for the region now being processed.

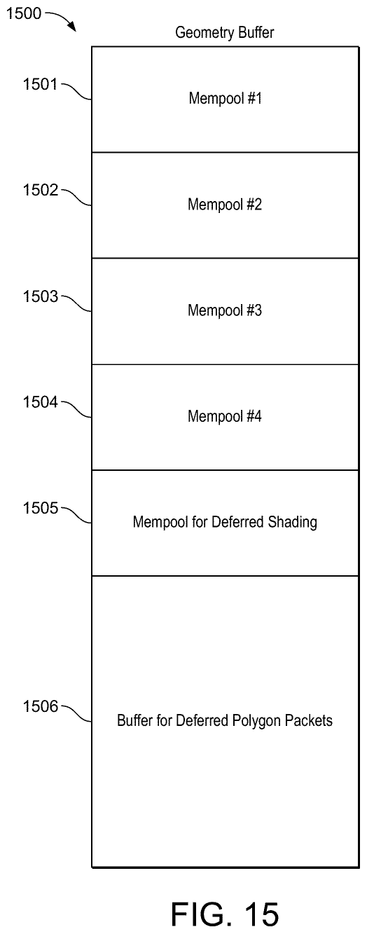

FIG. 15 shows an exemplary layout of the geometry buffer where the various data is stored in the present embodiment (which geometry buffer will use heap chunks as illustrated in FIGS. 11-14).

As shown in FIG. 15, the geometry buffer 1500 may include, e.g. four memory pools 1501, 1502, 1503 and 1504 that are used by the geometry packet pipeline during processing of the geometry. There is then a further memory pool 1505 that is used for geometry packets when performing deferred geometry shading, and a buffer 1506 for storing processed primitive packets created from deferred geometry shaded packets. The size of this buffer 1506 may set the limit for the number of packets for which geometry processing can be deferred.

The above describes the operation of the graphics processor in the present embodiments in the case where it is permitted for some geometry processing to be deferred until the rendering stage (which will normally be the desired form of operation, where possible, as it would normally be desirable to defer some of the geometry processing to the rendering stage where that is appropriate and possible).

However, as discussed above, the Applicants have recognised that there may be circumstances where it is not desirable to defer any geometry processing to the rendering stage (circumstances when no geometry processing should be deferred until the rendering stage for a given render output (e.g. draw call)).

For example, there may be a draw call that has a side effect, which means that the geometry must be processed in the draw call order (for the side effect to happen in draw call order), such that no geometry processing should be deferred for that draw call.

Moreover, the Applicants have recognised that there could be a dependency between a, e.g. draw call, for which no geometry processing should be deferred until the rendering stage and a preceding, e.g. draw call, for which geometry processing has been allowed to be deferred. For example, a first draw call #0 for which geometry processing is allowed to be deferred could read a buffer A when performing vertex shading and be followed by a draw call #1 that writes to the buffer A when performing vertex shading (i.e. for which there is a side effect (such that no geometry processing should be deferred for that second draw call #1)).

Because the second draw call #1 writes to the buffer A, it may need to be ensured that the first draw call #0 performs all it's reads to the buffer A before the second draw call #1 writes to the buffer A. This being the case, the Applicants have recognised that any geometry processing that has previously been deferred for the first draw call #0 should be performed before any geometry processing for the second draw call #1 is performed (to ensure that all the reads to the buffer A for the first draw call #0 are performed before any writes to the buffer A by the second draw call #1).

In the present embodiments, this issue is addressed and avoided by, in accordance with the technology described herein, identifying when previously deferred geometry processing should no longer be deferred until the rendering stage for a render output (such as a draw call), and in response to such a determination providing an indication that any previously deferred geometry processing should no longer be deferred until the rendering stage, in response to which indication the graphics processor then performs any (outstanding) previously deferred geometry processing.

In the present embodiments, the fact that previously deferred geometry processing should no longer be deferred for a render output is determined by the driver 10 for the graphics processor 2 in response to the API calls/commands that are provided to the driver 10 by an application 9 that requires graphics processing.

In particular, the driver 10 operates to identify that no geometry processing should be deferred for a render output based on the graphics processing that is indicated (requested) by an application, and in response to that includes an appropriate indication in the sequence of (graphics) processing that it provides to the graphics processor 2 to cause the graphics processor to perform the desired graphics processing (and in particular, in the sequence of geometry processing that it indicates to the graphics processor).

In the present embodiments, it is assumed that an application 9 provides to the driver 10 for the graphics processor 2 a sequence of API commands indicating desired graphics processing, with the driver 10 then correspondingly generating an appropriate sequence of commands (a command stream) for sending to the graphics processor 2 which commands the graphics processor will then execute to perform the desired graphics processing. (Other arrangements, such as providing a set of descriptors that define and indicate the graphics processing to be performed, would, of course, be possible.)

Thus, in the present embodiments, the driver 10 is configured to determine from the sequence commands provided by an application that there is a render output for which no geometry processing should be deferred to the rendering stage, and in response thereto include in the sequence of commands provided to the graphics processor an indication that previously deferred geometry processing should no longer be deferred until the rendering stage, in the present embodiments in the form of a barrier command that will, inter alia, have the effect of causing previously deferred geometry processing to be performed.

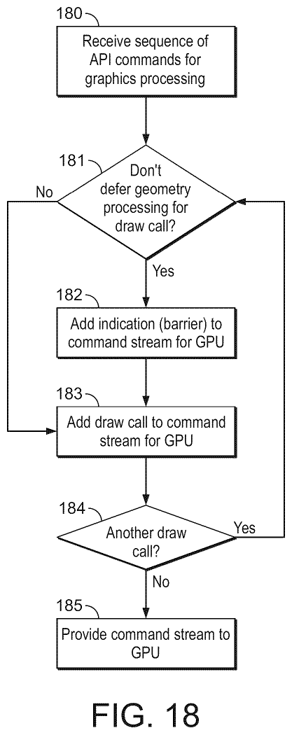

FIG. 18 shows this driver operation in the present embodiments.

As shown in FIG. 18, the driver will receive a sequence of graphics processing to be performed by the graphics processor in the form of a sequence of API commands from an application (step 180).

It is assumed in this regard that in these embodiments, the sequence of graphics processing will include (define) a sequence of render outputs in the form of draw calls to be generated. The draw calls may be a sequence of draw calls for a single render pass, or a sequence of draw calls that spans two or more render passes, for example.

For a respective (and each) render output (draw call) to be generated, the driver determines whether no geometry processing for that render output (draw call) should be deferred to the rendering stage (step 181).

When it is determined that no geometry processing should be deferred for a draw call, the driver includes an indication, in the form of a barrier, that previously deferred geometry processing should no longer be deferred until the rendering stage in the sequence of processing (the command stream) that it will provide to the graphics processor (step 182), followed by a command to generate the draw call itself (step 183).

On the other hand, where it is determined at step 181 that geometry processing can be deferred for a draw call, the driver simply includes a command to generate the draw call in question (without including any indication (a barrier indicating) that previously deferred geometry processing should no longer be deferred until the rendering stage) in the sequence of processing (the command stream) that is provided to the graphics processor (step 183).

This is done for each draw call (render output) in the sequence of a graphics processing received from the application (step 184).

Once the complete sequence of graphics processing requested by the application has been considered, the so-generated sequence of processing (command stream) can be and is provided to the graphics processor for execution (step 185), for example by storing the command stream appropriately in memory for retrieval by the graphics processor 2.

By way of example, for the following sequence of exemplary commands received from an application for graphics processing:
CMD begin render pass—a command to start the generation of a sequence of draw calls for a render pass
CMD draw VS read A—a command to perform vertex shading for a draw call that reads buffer A
CMD pipeline barrier (vertex→vertex)—a command indicating that all preceding vertex shaders must complete before passing the barrier
CMD draw VS write A—a command to perform vertex shading for a draw call that will write to buffer A
CMD end render pass—a command to end the render pass
   the driver will identify that the “pipeline barrier” command in the sequence of commands received from the application means that no geometry processing should be deferred for the render output that follows that pipeline barrier, and accordingly that any deferred geometry processing for any render output that precedes that pipeline barrier command should no longer be deferred, and, for example, generate the following corresponding sequence of commands that are provided to the graphics processor to perform the corresponding geometry processing:
G: RPASS_BEGIN—a command to begin the render pass
G: RUN_VS READ A—a command to perform the vertex shading for the draw call output that reads the buffer A
G: BARRIER src stage=vertex, dst stage=vertex-a “barrier” command that acts as the indication that previously deferred geometry processing should no longer be deferred until the rendering stage (and that indicates that all the “src stage” vertex shading must be completed before any of the “dst stage” vertex shading is begun)
G: RUN_VS WRITE A—a command to perform the vertex shading for the draw call that writes to the buffer A
G: RPASS_END—a command indicating the end of the render pass

In the present embodiments, the driver 10 will accordingly send an appropriate sequence of graphics processing (a command stream) to the graphics processor for execution (to be performed by the graphics processor), in response to which the graphics processor 2 will perform the indicated graphics processing accordingly.

In the present embodiments, the graphics processor 2 is in particular configured to respond appropriately to an indication (barrier) as discussed above that previously deferred geometry processing should no longer be deferred until the rendering stage.

In the present embodiments, this operation is controlled and performed in particular by the barrier control unit (circuit) 50 and deferred shader stage unit (circuit) 51 (see FIG. 3).

In particular, the barrier control circuit 50 and the deferred shader stage circuit 51 receive the sequence of commands provided to the graphics processor and when they receive (see) a barrier command (an indication that previously deferred geometry processing should no longer be deferred until the rendering stage) in the sequence of commands, trigger the corresponding operation in the manner of the present embodiments and the technology described herein, namely to perform previously deferred geometry processing before the geometry processing for a render output for which no geometry processing should be deferred is performed.

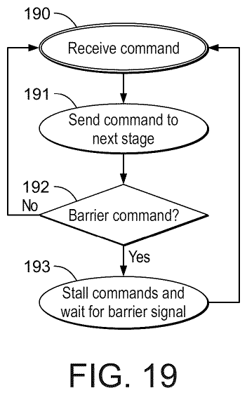

FIGS. 19, 20 and 21 illustrate this operation in the present embodiments.

FIG. 19 is a flow chart showing the operation of the barrier control unit 50 in the present embodiments.

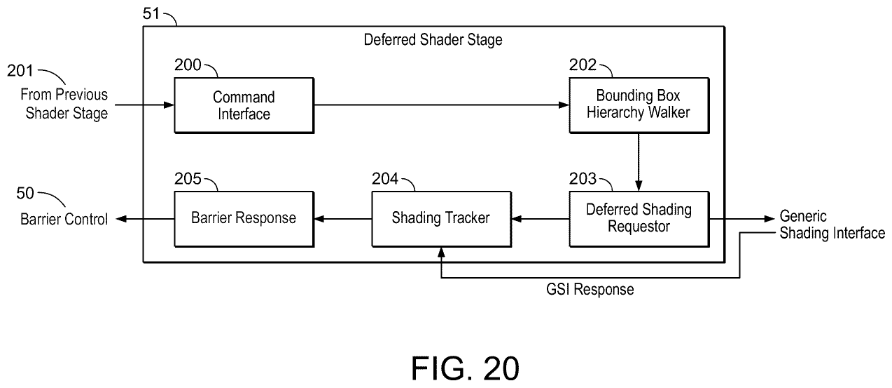

FIG. 20 shows the deferred shader stage unit 51 of the present embodiments in more detail.

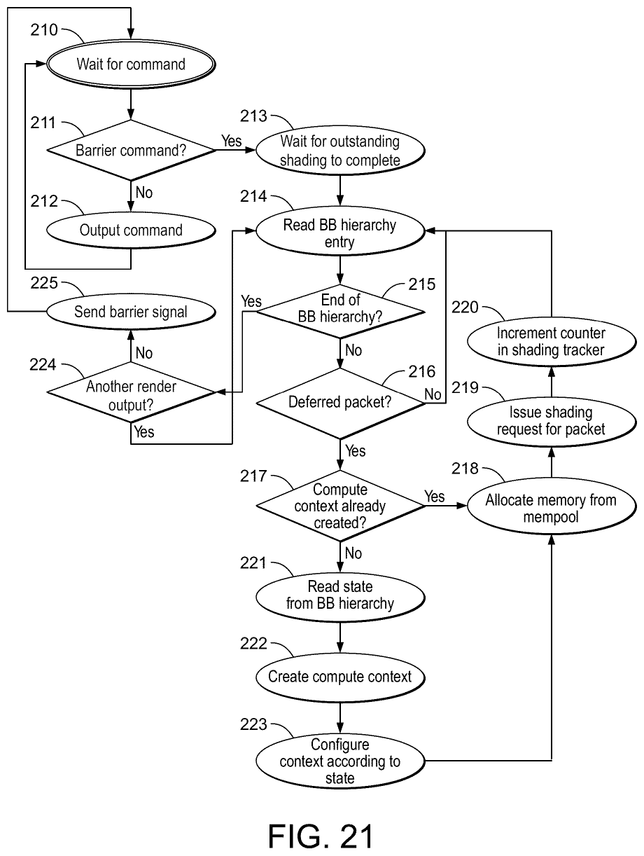

FIG. 21 is a corresponding flow chart showing the operation of the deferred shader stage control unit 51 in the present embodiments.

As shown in FIG. 19, the barrier control unit 50 will receive the sequence of commands indicating the graphics processing to be performed (step 190) and for each command in the sequence, send the command to the next stage of the geometry packet pipeline (which in the present embodiments will be the input packetizer 43 (see FIG. 3)) (step 191). The barrier control unit 50 also determines whether the command is a barrier command indicating that previously deferred geometry processing should no longer be deferred until the rendering stage (step 192).

In the case where the command is not a barrier command, the process, as shown in FIG. 19, simply proceeds to the next command in the sequence, and so on.

On the other hand, in the case where the command is a barrier command, the barrier control unit 50 operates to stall the processing of commands following the barrier command until a “release” barrier signal is received from the deferred stager stage unit 51 (this will be discussed in more detail below), at which point it then resumes the processing and passing of commands in the command stream (step 193).

As will be appreciated from the operation of the barrier control unit shown in FIG. 19, when a barrier command indicating that previously deferred geometry processing should no longer be referred is encountered, that barrier command and any commands preceding it in the command stream will still be passed through the geometry packet pipeline by the barrier control unit 50, but any following commands will be stalled. Accordingly, the geometry processing that precedes (that is in front of) the barrier will still be processed through the geometry processing pipeline, with the barrier command, in effect, following that processing through the pipeline until the barrier command reaches the deferred shader stage unit 51.

In the present embodiments, in response to a barrier command reaching the deferred shader stage unit 51, the deferred shader stage unit 51 operates to trigger the performing of any previously deferred geometry processing (in response to the “barrier”), and when that previously deferred geometry processing has been completed, signals that back to the barrier control unit 50 for the barrier control unit to then release any stalled commands that follow the barrier, so that the following commands (and thus render outputs (draw calls)) can then be processed.

FIG. 20 shows the deferred shader stage control unit 51 of the present embodiments in more detail. FIG. 21 is a corresponding flowchart showing the operation of the deferred shader stage control unit 51 in the present embodiments.

As shown in FIG. 20, the deferred shader stage control unit 51 includes a command interface 200 that receives appropriate commands from the previous geometry shading stage 201.

When the command interface 200 receives a command (step 210, FIG. 21), the command interface 200 (FIG. 20) first determines whether the command is a barrier command indicating that previously deferred geometry shading should no longer be deferred (step 211, FIG. 21).

In the event that the command is not a barrier command indicating that previously deferred geometry shading should no longer be deferred, then the command interface 200 simply outputs the command in the normal manner (and the processing will proceed in the normal manner) (step 212, FIG. 21). (The command interface 200 will then wait for the next command, and so on.)

On the other hand, in the event that the command interface 200 identifies a barrier command at step 211, the command interface 200 then operates to trigger the performing of any previously deferred (and still outstanding) geometry processing for render outputs (draw calls) that preceded the barrier command.

In this case, the command interface 200 waits for any outstanding geometry shading to complete (step 213, FIG. 21) and then signals a bounding box hierarchy walker 202 to walk the binning bounding box hierarchy for a previously geometry processed render output (draw call) (that has not yet been rendered) to identify any packets for the render output (draw call) for which the geometry processing has been deferred.

The bounding box hierarchy walker (walking circuit) 202 (FIG. 20) traverses the bounding box hierarchy binning data structure generated by the distributed binning cores to determine those geometry/primitive packets that apply to the render output (draw call) in question and whether any of those packets have had their geometry processing deferred (steps 214, 215 and 216 in FIG. 21).

When a packet applying to a render output for which the geometry processing has been deferred is identified at step 216, the appropriate geometry processing for that packet is triggered by a deferred shading requester circuit 203 (FIG. 20) of the deferred shader stage control unit 51. (For any packets applying to the render output for which geometry processing has been deferred, the appropriate deferred shading operation is triggered (issued) by the deferred shading requester 203.)

When deferred geometry processing for the packet is to be performed, as shown in FIG. 21 it is first determined whether the appropriate compute shading context has already been created (step 217).

If so, an appropriate memory allocation is allocated for the result of the geometry processing of the packet (step 218), the appropriate geometry shading request for the packet is issued (step 219) and a counter in a geometry processing shading tracker 204 (FIG. 20) is incremented (step 220) (this counter is used to track and determine when all the packets within the render output being considered have had their deferred geometry processing completed).

In the case where the compute context for the deferred geometry shading has not already been created (step 217), then the appropriate compute shading state is read from the bounding box hierarchy binning data structure (step 221), the appropriate compute shading context is created (step 222), and configured according to the read state for the packet in question (step 223).

Then, again, appropriate memory is allocated, a shading request for the packet is issued, and the shading tracker counter is incremented (steps 218, 219 and 220).

In the present embodiments, the deferred geometry shading for a packet is triggered and controlled by sending a shading request for the packet to the distributed binning control of a shader core, for the distributed binning core of the shader core to then trigger the deferred geometry shading for the packet in question and then generate an appropriate processed packet and updated binning data structure (bounding box hierarchy) for the processed (and shaded) packet. This operation is performed in the manner discussed above with reference to FIG. 6 (in the case where deferred packet shading is not enabled at step 91).

Thus, in this case, when the packet for which deferred geometry shading is to be performed is sent to a distributed binning core at the rendering stage, the distributed binning core will first issue the deferred geometry shading for the packet (step 92), and then when that shading is complete (step 93) process the packet in the manner discussed above with reference to FIG. 6 to generate the appropriate primitive packet (steps 94-105) and update the corresponding binning data structure (bounding box hierarchy) accordingly. The binning stage also in an embodiment correspondingly sets the packet as not (no longer) having any geometry processing “deferred” for it in the updated binning structure, so that when the updated binning structure is used, the packet will be seen as being “complete”, and not needing further geometry processing to be performed for it (as that further geometry processing will now have been done).

As shown in FIG. 6, in this case, as the processing is being performed at the deferred shading point (step 106), the processed packet that has been generated by the distributed binning core after the deferred shading has been performed is stored in a “short-lived” heap in memory (steps 108 and 109) (rather than being stored in a longer-term memory heap).

As shown in FIG. 21, the process then continues to read further entries in the bounding box hierarchy binning data structure to identify all packets in the render output for which geometry processing has been deferred and to trigger that geometry processing appropriately.

A shading tracker (circuit) 224 for the deferred shader stage unit 51 maintains appropriate counters to track the packets for which deferred geometry shading is being performed for a render output, and to correspondingly track when all the deferred geometry processing of packets for the render output has been completed. To facilitate this, as shown in FIG. 20, the shading tracker 204 will receive responses from the shader cores indicating when the deferred geometry processing for a packet has been completed, so that it can then decrement the corresponding render output counter.

Once a deferred geometry shading counter for a render output has been decremented to 0, that is taken as indicating that the geometry processing for all the deferred packets in the render output has been completed, such that the geometry processing will then have been completed for all the packets for the render output in question.

Once any outstanding deferred geometry processing for a render output has been completed, it is then determined whether there are any further render outputs for which deferred geometry processing could still be outstanding (step 224, FIG. 21). If so, the process of determining whether there is any deferred geometry processing still to be completed, and of completing any outstanding previously deferred geometry processing, for those render outputs is performed accordingly.

On the other hand, once all the previously deferred geometry processing (for all outstanding render outputs (draw calls)) has been completed, the shading tracker 204 signals a barrier response circuit 205 of the deferred shader stage control unit 51 (FIG. 20) to signal to the barrier control unit 50 that the barrier can be released (step 225, FIG. 21).

As discussed above, in response to this barrier release signal, the barrier control unit 50 “releases” the barrier (any stalled commands following the barrier), and commences passing the commands and geometry processing through the geometry processing pipeline again (step 193, FIG. 19).

The “released” render outputs (draw calls) following a barrier may be and are in an embodiment again processed in the normal manner including, e.g., and in an embodiment, again allowing geometry processing for those render outputs to be deferred until the rendering stage where it is appropriate to do that, e.g. and in an embodiment, unless and until another indication (barrier indicating) that previously deferred geometry processing should no longer be deferred arises in the sequence of geometry processing.

This process will be repeated each time an appropriate indication (barrier indicating) that previously deferred geometry processing should no longer be deferred is encountered in the sequence of geometry processing (the command stream) that the graphics processor receives.

It will be appreciated from the above that in the operation of the present embodiments, an appropriate indication that previously deferred geometry processing should no longer be deferred is sent to the graphics processor and in particular to the geometry processing pipeline of the graphics processor, with the graphics processor hardware then detecting that indication and in response thereto stalling the render output for which no geometry processing should be deferred (that has a side effect) at the top of the geometry processing pipeline, waiting until all render outputs (draw calls) that preceded the barrier have completed passing through the geometry processing pipeline, then signalling that all previously deferred geometry shading should now be performed (that all deferred packets should be converted to immediate packets), to trigger and thereby triggering the deferred geometry shading (deferred shading for all deferred packets) (which will also update the information in the binning data structures, e.g. bounding box hierarchies). Once all the deferred shading has been completed, that is signalled back to the geometry processing pipeline, and the stalled render output (draw call) is released and the processing continues as normal.

The Applicants have further recognised in this regard that when performing the deferred geometry processing in this manner, that could potentially trigger an out of memory situation for the graphics processor. In the present embodiments, this is handled in the normal manner for an out of memory situation in the graphics processor and graphics processing system in question, for example by stalling the processing until more memory can be allocated/becomes available.

Although the present embodiments have been described above with reference to the generation of geometry packets and the possibility of deferring geometry processing for respective geometry packets, it will be appreciated by those skilled in the art that the deferral (or not) of geometry processing could be considered and applied in relation to other “units” of geometry, such as for example, for individual primitives. For example, it could be determined to defer vertex shading for respective individual primitives until the rendering stage, if desired. In such cases, the operation in the manner of the technology described herein will proceed in a corresponding manner, for example to identify any and all primitives for which the vertex shading has been deferred, and to trigger that deferred vertex shading appropriately.

As will be appreciated from the above, the technology described herein, in its embodiments at least, can provide improved tile-based graphics processing pipeline operation, in particular in the case where geometry processing can be deferred until the rendering stage, but there may be render outputs having side effects for which it must be ensured that the geometry processing is completed in a particular order. This is achieved, in the embodiments of the technology described herein at least, by, when it is identified that no geometry processing should be deferred for a render output, providing an indication that previously deferred geometry processing should no longer be deferred, in response to which indication the graphics processor is operable to complete any previously deferred geometry processing.

Whilst the foregoing detailed description has been presented for the purposes of illustration and description, it is not intended to be exhaustive or to limit the technology described herein to the precise form disclosed. Many modifications and variations are possible in the light of the above teaching. The described embodiments were chosen in order to best explain the principles of the technology described herein and its practical applications, to thereby enable others skilled in the art to best utilise the technology described herein, in various embodiments and with various modifications as are suited to the particular use contemplated. It is intended that the scope be defined by the claims appended hereto.

1. A method of operating a graphics processing system, the graphics processing system including a graphics processor that executes a tile-based graphics processing pipeline to generate an output, the graphics processing pipeline being executed comprising:
a sequence of one or more geometry processing stages to perform geometry processing;
a binning stage that generates data structures for identifying geometry to be processed for respective rendering tiles of a render output being generated; and
a rendering stage for rendering tiles of a render output being generated;
wherein some of the geometry processing of the sequence of one or more geometry processing stages of the graphics processing pipeline being executed can be deferred until the rendering stage for geometry being processed;
the method comprising:
determining that previously deferred geometry processing for a render output should no longer be deferred until the rendering stage;
in response to determining that previously deferred geometry processing for a render output should no longer be deferred until the rendering stage, providing an indication that previously deferred geometry processing should no longer be deferred until the rendering stage to the graphics processor; and
the graphics processor in response to the indication, performing previously deferred geometry processing.

2. The method of claim 1, comprising:
determining that previously deferred geometry processing for a render output should no longer be deferred until the rendering stage based on one or more of:
whether it is necessary to ensure that geometry processing for a render output should be performed in a particular order;
whether geometry processing for a render output has a side effect; and
whether there is a barrier in the sequence of graphics processing indicated by the application that is requesting the graphics processing that indicates that processing prior to the barrier should be completed before passing the barrier.

3. The method of claim 1, wherein:
the indication that previously deferred geometry processing should no longer be deferred until the rendering stage is provided as part of the sequence of processing that is indicated to the graphics processor for causing the graphics processor to perform the graphics processing.

4. The method of claim 3, wherein the indication is in the form of a barrier in the sequence of graphics processing that is provided to the graphics processor, which barrier when encountered in the sequence of graphics processing has the effect of causing previously deferred geometry processing to be performed.

5. The method of claim 1, comprising in response to the indication indicating that previously deferred geometry processing should no longer be deferred until the rendering stage:
for any render output that has completed its geometry processing but has not yet reached the rendering stage, performing any geometry processing that has been deferred for the render output; and
for any render output that is still undergoing geometry processing, completing all remaining geometry processing for the render output, and performing any geometry processing that has been deferred for the render output.

6. The method of claim 1, comprising:
identifying previously deferred geometry processing that should no longer be deferred in response to an indication that previously deferred geometry processing should no longer be deferred until the rendering stage, from a binning data structure or structures for a render output.

7. The method of claim 1, comprising:
not performing geometry processing for a render output for which it has been determined that no geometry processing should be deferred until the rendering stage until all previously deferred geometry processing that is to be performed has been performed.

8. The method of claim 1, comprising:
in response to an indication that previously deferred geometry processing should no longer be deferred until the rendering stage:
stalling the geometry processing for a render output that is associated with and/or that follows the indication;
performing previously deferred geometry processing, and when the previously deferred geometry processing has been performed, signalling that the previously deferred geometry processing has been performed; and
in response to the signal that the previously deferred geometry processing has been performed, starting and performing the geometry processing for the stalled render output.

9. The method of claim 1, wherein
the geometry processing generates packets that each store data for a set of one or more primitives to be processed for the render output; and
the geometry processing is deferred for and in respect of individual geometry packets.

10. The method of claim 1, wherein the render output comprises a draw call.

11. A graphics processing system, the graphics processing system comprising:
a graphics processor comprising processing circuits configured to execute a tile-based graphics processing pipeline to generate an output, the graphics processing pipeline comprising:
a sequence of one or more geometry processing stages to perform geometry processing;
a binning stage that generates data structures for identifying geometry to be processed for respective rendering tiles of a render output being generated; and
a rendering stage for rendering tiles of a render output being generated;
wherein some of the geometry processing of the sequence of one or more geometry processing stages of a graphics processing pipeline being executed can be deferred until the rendering stage for geometry being processed;
the graphics processing system further comprising:
a processing circuit configured to:
determine whether previously deferred geometry processing for a render output should no longer be deferred until the rendering stage; and
when it is determined that previously deferred geometry processing for a render output should no longer be deferred until the rendering stage, provide an indication that previously deferred geometry processing should no longer be deferred until the rendering stage;
the graphics processor further configured to:
in response to an indication that previously deferred geometry processing should no longer be deferred until the rendering stage, perform previously deferred geometry processing.

12. The graphics processing system of claim 11, wherein the processing circuit is configured to determine that previously deferred geometry processing for a render output should no longer be deferred until the rendering stage based on one or more of:
whether it is necessary to ensure that geometry processing for a render output should be performed in a particular order;
whether geometry processing for a render output has a side effect; and
whether there is a barrier in the sequence of graphics processing indicated by the application that is requesting the graphics processing that indicates that processing prior to the barrier should be completed before passing the barrier.

13. The graphics processing system of claim 11, wherein:
the indication that previously deferred geometry processing should no longer be deferred until the rendering stage is provided as part of the sequence of processing that is indicated to the graphics processor for causing the graphics processor to perform the graphics processing.

14. The graphics processing system of claim 11, wherein:
the indication is in the form of a barrier in the sequence of graphics processing that is provided to the graphics processor, which barrier when encountered in the sequence of graphics processing has the effect of causing previously deferred geometry processing to be performed.

15. The graphics processing system of claim 11, wherein the graphics processor is configured to, in response to an indication indicating that previously deferred geometry processing should no longer be deferred until the rendering stage:
for a render output that has completed its geometry processing but has not yet reached the rendering stage, perform any geometry processing that has been deferred for the render output; and
for a render output that is still undergoing geometry processing, complete all remaining geometry processing for the render output, perform any geometry processing that has been deferred for the render output.

16. The graphics processing system of claim 11, wherein the graphics processor comprises a processing circuit configured to:
identify previously deferred geometry processing that should no longer be deferred in response to an indication that previously deferred geometry processing should no longer be deferred until the rendering stage from a binning data structure or structures for a render output.

17. The graphics processing system of claim 11, wherein the graphics processor is configured to:
not perform geometry processing for a render output for which it has been determined that no geometry processing should be deferred until the rendering stage until previously deferred geometry processing that is to be performed has been performed.

18. The graphics processing system of claim 11, wherein the graphics processor is configured to, in response to an indication that previously deferred geometry processing should no longer be deferred until the rendering stage:
stall the geometry processing for a render output that is associated with and/or that follows the indication;
perform previously deferred geometry processing, and when the previously deferred geometry processing has been performed, signal that the previously deferred geometry processing has been performed; and
in response to the signal that the previously deferred geometry processing has been performed, start and perform the geometry processing for the stalled render output.

19. The graphics processing system of claim 11, wherein:
the geometry processing generates packets that each store data for a set of one or more primitives to be processed for the render output; and
the geometry processing is deferred for and in respect of individual geometry packets.

20. A graphics processor, the graphics processor comprising:
processing circuits configured to execute a tile-based graphics processing pipeline to generate an output, the graphics processing pipeline comprising:
a sequence of one or more geometry processing stages to perform geometry processing;
a binning stage that generates data structures for identifying geometry to be processed for respective rendering tiles of a render output being generated; and
a rendering stage for rendering tiles of a render output being generated;
wherein some of the geometry processing of the sequence of one or more geometry processing stages of a graphics processing pipeline being executed can be deferred until the rendering stage for geometry being processed;
the graphics processor further configured to:
in response to an indication that previously deferred geometry processing should no longer be deferred until the rendering stage, perform previously deferred geometry processing.

21. A non-transitory computer readable storage medium storing computer software code which when executing on at least one processor, performs a method of operating a graphics processing system, the graphics processing system including a graphics processor that executes a tile-based graphics processing pipeline to generate an output, the graphics processing pipeline being executed comprising:
a sequence of one or more geometry processing stages to perform geometry processing;
a binning stage that generates data structures for identifying geometry to be processed for respective rendering tiles of a render output being generated; and
a rendering stage for rendering tiles of a render output being generated;
wherein some of the geometry processing of the sequence of one or more geometry processing stages of the graphics processing pipeline being executed can be deferred until the rendering stage for geometry being processed;
the method comprising:
determining that previously deferred geometry processing for a render output should no longer be deferred until the rendering stage;
in response to determining that previously deferred geometry processing for a render output should no longer be deferred until the rendering stage, providing an indication that previously deferred geometry processing should no longer be deferred until the rendering stage to the graphics processor; and
the graphics processor in response to the indication, performing previously deferred geometry processing.
